(19) United States
(12) Patent Application Publication
(10) Pub. No.: US 2025/0001611 A1
(43) Pub. Date: Jan. 2, 2025

(54) SYSTEMS, METHODS, AND CONTROL MODULES FOR GRASPING BY ROBOTS

(71) Applicant: Sanctuary Cognitive Systems Corporation, Vancouver (CA)

(72) Inventor: Suzanne Gildert, Vancouver (CA)

(21) Appl. No.: 18/759,936

(22) Filed: Jun. 30, 2024

Related U.S. Application Data
(60) Provisional application No. 63/524,507, filed on Jun. 30, 2023.

(51) Int. Cl. B25J 9/16

(52) U.S. Cl. CPC B25J 9/1697

(57) ABSTRACT

Systems, methods, and control modules for controlling robot systems are described. An object is represented by a platonic representation, which is one or more basic geometric shapes which approximate the object. A library of ways to grasp these basic geometric shapes is accessed, and an appropriate way to grasp a shape is selected and used to grasp the object at a location where the basic geometric shape at least approximately corresponds to the grasp.

### TECHNICAL FIELD

The present systems, methods and control modules generally relate to controlling robot systems, and in particular relate to controlling end effectors of robot systems to grasp objects.

### DESCRIPTION OF THE RELATED ART

Robots are machines that may be deployed to perform work. General purpose robots (GPRs) can be deployed in a variety of different environments, to achieve a variety of objectives or perform a variety of tasks. Robots can engage, interact with, and manipulate objects in a physical environment. It is desirable for a robot to be able to effectively grasp and engage with objects in the physical environment.

### BRIEF SUMMARY

According to a broad aspect, the present disclosure describes a robot system comprising: a robot body having at least one end effector; at least one sensor; a robot controller including at least one processor and at least one non-transitory processor-readable storage medium storing: a library of three-dimensional shapes, a library of grasp primitives; and processor-executable instructions which, when executed by the at least one processor, cause the robot system to: capture, by the at least one sensor, sensor data about an object; access, by the robot controller, a platonic representation of the object comprising a set of at least one three-dimensional shape from the library of the three-dimensional shapes, the platonic representation of the object based at least in part on the sensor data; select, by the robot controller and from the library of grasp primitives, a grasp primitive based at least in part on at least one three-dimensional shape in the platonic representation of the object; and control, by the robot controller, the end effector to apply the grasp primitive to grasp the object at a grasp location of the object at least approximately corresponding to the at least one three-dimensional shape upon which the selection of the grasp primitive is at least partially based.

The processor-executable instructions may further cause the at least one processor to: identify, by the at least one processor, the object; and the processor-executable instructions which cause the robot controller to access the platonic representation of the object may cause the robot controller to: access a three-dimensional model of the object from a database, the three-dimensional model including the platonic representation of the object.

The processor-executable instructions which cause the robot controller to access the platonic representation of the object may cause the at least one processor to: generate the at least one platonic representation of the object, by approximating the object with the set of at least one three-dimensional shape. The processor-executable instructions which cause the at least one processor to generate the at least one platonic representation of the object, may cause the at least one processor to: identify at least one portion of the object suitable for representation by respective three-dimensional shapes; and for each portion of the at least one portion: access a geometric three-dimensional shape model which is similar in shape to the portion; and transform the accessed geometric three-dimensional shape model to fit the portion. The processor-executable instructions which cause the at least one processor to, for each portion of the at least one portion, transform the accessed three-dimensional geometric shape model to fit the portion, may cause the at least one processor to: transform a size of the geometric three-dimensional shape model in at least one dimension to fit the size of the geometric three-dimensional shape model to the portion; transform a position of the geometric three-dimensional shape model to align with a position of the portion; or rotate the geometric three-dimensional shape model to fit the geometric model to an orientation of the portion.

The processor-executable instructions may further cause the robot controller to select the grasp location of the object.

The processor-executable instructions may further cause the robot controller to: access a work objective of the robot system; select the grasp location as a location of the object relevant to the work objective.

The processor-executable instructions may further cause the robot controller to: identify, based on the sensor data, at least one graspable feature of the object; select one or more of the at least one graspable feature as the grasp location of the object.

The processor-executable instructions may further cause the robot controller to: evaluate grasp-effectiveness for a plurality of grasp primitive-location pairs, each grasp primitive-location pair including a respective three-dimensional shape in the platonic representation of the object and a respective grasp primitive from the library of grasp primitives; and select the grasp location as a location of the three-dimensional shape in a grasp primitive-location pair having a grasp-effectiveness which exceeds a threshold, and the processor-executable instructions which cause the robot controller to select the grasp primitive may cause the robot controller to select the grasp primitive as a grasp primitive in the primitive-location pair having the highest grasp-effectiveness. The processor-executable instructions which cause the robot controller to evaluate grasp-effectiveness for a plurality of grasp primitive-location pairs may cause the robot controller to, for each grasp primitive-location pair: simulate grasping of the respective three-dimensional shape in the platonic representation of the object, by applying the respective grasp primitive; generate a grasp-effectiveness score indicative of effectiveness of simulated grasping.

The processor-executable instructions may further cause the robot controller to: access a grasp heatmap for the object, the grasp heatmap indicative of grasp areas of the object; and select the grasp location as a grasp area of the object, and the processor-executable instructions which cause the robot controller to select the grasp primitive may cause the robot controller to select the grasp primitive based on the at least one three-dimensional shape in the platonic representation of the object which at least approximately corresponds to the grasp location.

The at least one sensor may include one or more sensors selected from a group of sensors consisting of: an image sensor operable to capture image data; an audio sensor operable to capture audio data; a tactile sensor operable to capture tactile data; a haptic sensor which captures haptic data; an actuator sensor which captures actuator data indicating a state of a corresponding actuator; an inertial sensor which captures inertial data; a proprioceptive sensor which captures proprioceptive data indicating a position, movement, or force applied for a corresponding actuatable member of the robot body; and a position encoder which captures position data about at least one joint or appendage of the robot body.

The processor-executable instructions may further cause the at least one sensor to capture further sensor data indicative of engagement between the end effector and the object, as the end effector is controlled to apply the grasp primitive; the processor executable instructions which cause the robot controller to control the end effector to apply the grasp primitive to grasp the object may further cause the robot controller to adjust control of the end effector based on the further sensor data. The further sensor data may be indicative of engagement between the end effector and the object being different from expected engagement between the end effector and the at least one three-dimensional shape upon which the selection of the grasp primitive is at least partially based. The processor-executable instructions which cause the robot controller to adjust control of the end effector based on the further sensor data may cause the robot controller to optimize actuation of at least one member of the end effector to increase grasp effectiveness.

The robot body may carry the at least one sensor and the robot controller.

The robot system may further comprise a remote device remote from the robot body, and a communication interface which communicatively couples the remote device and the robot body, and: the robot body may carry the at least one sensor; the remote device may include the robot controller; the processor-executable instructions may further cause the communication interface to transmit the sensor data from the robot body to the remote device; and the processor-executable instructions which cause the robot controller to control the end effector may cause the robot controller to prepare and send control instructions to the robot body via the communication interface.

The robot system may further comprise a remote device remote from the robot body, and a communication interface which communicatively couples the remote device and the robot body, and: the robot body may carry the at least one sensor, a first processor of the at least one processor, and a first non-transitory processor-readable storage medium of the at least one non-transitory processor-readable storage medium; the remote device may include a second processor of the at least one processor, and a second non-transitory processor-readable storage medium of the at least one non-transitory processor-readable storage medium; the processor-executable instructions may include first processor-executable instructions stored at the first non-transitory processor-readable storage medium that when executed cause the robot system to: capture the sensor data by the at least one sensor; transmit, via the communication interface, the sensor data from the robot body to the remote device; and control, by the first at least one processor, the end effector to apply the grasp primitive to grasp the object; and the processor-executable instructions may include second processor-executable instructions stored at the second non-transitory processor-readable storage medium that when executed cause the robot system to: access, from the second non-transitory processor-readable storage medium, the platonic representation of the object; select, by the second processor, the grasp primitive; and transmit, via the communication interface, data indicating the grasp primitive and the platonic representation of the object to the robot body.

According to another broad aspect, the present disclosure describes a method for operating a robot system including a robot body, at least one sensor, and a robot controller including at least one processor and at least one non-transitory processor-readable storage medium storing a library of three-dimensional shapes and a library of grasp primitives, the method comprising: capturing, by the at least one sensor, sensor data about an object; accessing, by the robot controller, a platonic representation of the object comprising a set of at least one three-dimensional shape from the library of the three-dimensional shapes, the platonic representation of the object based at least part on the sensor data; selecting, by the robot controller and from the library of grasp primitives, a grasp primitive based at least in part on at least one three-dimensional shape in the platonic representation of the object; and controlling, by the robot controller, an end effector of the robot body to apply the grasp primitive to grasp the object at a grasp location of the object at least approximately corresponding to the at least one three-dimensional shape upon which the selection of the grasp primitive is at least partially based.

The method may further comprise: identifying, by the at least one processor, the object, and accessing the platonic representation of the object may comprise accessing a three-dimensional model of the object from a database, the three-dimensional model including the platonic representation of the object.

Accessing the platonic representation of the object may comprise generating the at least one platonic representation of the object, by approximating the object with the set of at least one three-dimensional shape. Generating the at least one platonic representation of the object may comprise: identifying at least one portion of the object suitable for representation by respective three-dimensional shapes; and for each portion of the at least one portion: accessing a geometric three-dimensional shape model which is similar in shape to the portion; and transforming the accessed geometric three-dimensional shape model to fit the portion.

For each portion of the at least one portion, transforming the accessed three-dimensional geometric shape model to fit the portion may comprise: transforming a size of the geometric three-dimensional shape model in at least one dimension to fit the size of the geometric three-dimensional shape model to the portion; transforming a position of the geometric three-dimensional shape model to align with a position of the portion; or rotating the geometric three-dimensional shape model to fit the geometric model to an orientation of the portion.

The method may further comprise selecting, by the robot controller, the grasp location of the object.

The method may further comprise: accessing, by the robot controller, a work objective of the robot system; selecting, by the robot controller, the grasp location as a location of the object relevant to the work objective.

The method may further comprise: identifying, by the robot controller based on the sensor data, at least one graspable feature of the object; and selecting, by the robot controller, one or more of the at least one graspable feature as the grasp location of the object.

The method may further comprise: evaluating, by the robot controller, grasp-effectiveness for a plurality of grasp primitive-location pairs, each grasp primitive-location pair including a respective three-dimensional shape in the platonic representation of the object and a respective grasp primitive from the library of grasp primitives; and selecting, by the robot controller, the grasp location as a location of the three-dimensional shape in a grasp primitive-location pair having a grasp-effectiveness which exceeds a threshold, and selecting the grasp primitive may comprise selecting the grasp primitive as a grasp primitive in the primitive-location pair having the highest grasp-effectiveness. Evaluating grasp-effectiveness for a plurality of grasp primitive-location pairs may comprise, for each grasp primitive-location pair: simulating grasping of the respective three-dimensional shape in the platonic representation of the object, by applying the respective grasp primitive; and generating a grasp-effectiveness score indicative of effectiveness of simulated grasping.

The method may further comprise: accessing, by the robot controller, a grasp heatmap for the object, the grasp heatmap indicative of grasp areas of the object; and selecting, by the robot controller, the grasp location as a grasp area of the object, and selecting the grasp primitive may comprise selecting the grasp primitive based on the at least one three-dimensional shape in the platonic representation of the object which at least approximately corresponds to the grasp location.

Capturing sensor data about the object may comprise capturing sensor data by at least one sensor selected from a group of sensors consisting of: an image sensor operable to capture image data; an audio sensor operable to capture audio data; a tactile sensor operable to capture tactile data; a haptic sensor which captures haptic data; an actuator sensor which captures actuator data indicating a state of a corresponding actuator; an inertial sensor which captures inertial data; a proprioceptive sensor which captures proprioceptive data indicating a position, movement, or force applied for a corresponding actuatable member of the robot body; and a position encoder which captures position data about at least one joint or appendage of the robot body.

The method may further comprise capturing, by the at least one sensor, further sensor data indicative of engagement between the end effector and the object, as the end effector is controlled to apply the grasp primitive, and controlling the end effector to apply the grasp primitive to grasp the object may further comprise adjusting control of the end effector, by the robot controller, based on the further sensor data. The further sensor data may be indicative of engagement between the end effector and the object being different from expected engagement between the end effector and the at least one three-dimensional shape upon which the selection of the grasp primitive is at least partially based. Adjusting control of the end effector based on the further sensor data may comprise optimizing actuation of at least one member of the end effector to increase grasp effectiveness.

The robot body may carry the at least one sensor and the robot controller; and capturing the sensor data, accessing the platonic representation of the object, selecting a grasp primitive, and controlling the end effector may be performed at the robot body.

The robot system may further include a remote device remote from the robot body, and a communication interface which communicatively couples the remote device and the robot body; the robot body may carry the at least one sensor; the remote device may include the robot controller; capturing the sensor data may be performed at the robot body; the method may further comprise transmitting, by a communication interface, the sensor data from the robot body to the remote device; accessing the platonic representation of the object, selecting a grasp primitive, and controlling the end effector may be performed at the remote device; and controlling the end effector may comprise the robot controller preparing and sending control instructions to the robot body via the communication interface.

The robot system may further include a remote device remote from the robot body, and a communication interface which communicatively couples the remote device and the robot body; the robot body may carry the at least one sensor, a first processor of the at least one processor, and a first non-transitory processor-readable storage medium of the at least one non-transitory processor-readable storage medium; the remote device may include a second processor of the at least one processor, and a second non-transitory processor-readable storage medium of the at least one non-transitory processor-readable storage medium; capturing the sensor data and controlling the end effector may be performed at the robot body; accessing the platonic representation of the object and selecting the grasp primitive may be performed at the remote device; and the method may further comprise transmitting, by a communication interface, the sensor data from the robot body to the remote device; and the method may further comprise transmitting, by the communication interface, data indicating the grasp primitive and the platonic representation of the object to the robot body from the remote device.

According to yet another broad aspect, the present disclosure describes a robot control module comprising at least one non-transitory processor-readable storage medium storing a library of three-dimensional shapes, a library of grasp primitives, and processor-executable instructions or data that, when executed by at least one processor of a processor-based system, cause the processor-based system to: capture, by at least one sensor carried by a robot body of the processor-based system, sensor data about an object; access, by the at least one processor, a platonic representation of the object comprising a set of at least one three-dimensional shape from the library of the three-dimensional shapes, the platonic representation of the object based at least in part on the sensor data; select, by the at least one processor and from the library of grasp primitives, a grasp primitive based at least in part on at least one three-dimensional shape in the platonic representation of the object; and control, by the at least one processor, an end effector of the robot body to apply the grasp primitive to grasp the object at a grasp location of the object at least approximately corresponding to the at least one three-dimensional shape upon which the selection of the grasp primitive is at least partially based.

The processor-executable instructions or data may further cause the at least one processor to: identify, by the at least one processor, the object; and the processor-executable instructions or data which cause the at least one processor to access the platonic representation of the object may cause the at least one processor to: access a three-dimensional model of the object from a database, the three-dimensional model including the platonic representation of the object.

The processor-executable instructions or data which cause the at least one processor to access the platonic representation of the object may cause the at least one processor to: generate the at least one platonic representation of the object, by approximating the object with the set of at least one three-dimensional shape. The processor-executable instructions or data which cause the at least one processor to generate the at least one platonic representation of the object, may cause the at least one processor to: identify at least one portion of the object suitable for representation by respective three-dimensional shapes; and for each portion of the at least one portion: access a geometric three-dimensional shape model which is similar in shape to the portion; and transform the accessed geometric three-dimensional shape model to fit the portion. The processor-executable instructions or data which cause the at least one processor to, for each portion of the at least one portion, transform the accessed three-dimensional geometric shape model to fit the portion, may cause the at least one processor to: transform a size of the geometric three-dimensional shape model in at least one dimension to fit the size of the geometric three-dimensional shape model to the portion; transform a position of the geometric three-dimensional shape model to align with a position of the portion; or rotate the geometric three-dimensional shape model to fit the geometric model to an orientation of the portion.

The processor-executable instructions or data may further cause the at least one processor to select the grasp location of the object.

The processor-executable instructions or data may further cause the at least one processor to: access a work objective of the robot system; and select the grasp location as a location of the object relevant to the work objective.

The processor-executable instructions or data may further cause the at least one processor to: identify, based on the sensor data, at least one graspable feature of the object; and select one or more of the at least one graspable feature as the grasp location of the object.

The processor-executable instructions or data may further cause the at least one processor to: evaluate grasp-effectiveness for a plurality of grasp primitive-location pairs, each grasp primitive-location pair including a respective three-dimensional shape in the platonic representation of the object and a respective grasp primitive from the library of grasp primitives; and select the grasp location as a location of the three-dimensional shape in a grasp primitive-location pair having a grasp-effectiveness which exceeds a threshold, and the processor-executable instructions or data which cause the at least one processor to select the grasp primitive cause the at least one processor to select the grasp primitive as a grasp primitive in the primitive-location pair having the highest grasp-effectiveness. The processor-executable instructions or data which cause the at least one processor to evaluate grasp-effectiveness for a plurality of grasp primitive-location pairs may cause the at least one processor to, for each grasp primitive-location pair: simulate grasping of the respective three-dimensional shape in the platonic representation of the object, by applying the respective grasp primitive; and generate a grasp-effectiveness score indicative of effectiveness of simulated grasping.

The processor-executable instructions or data may further cause the at least one processor to: access a grasp heatmap for the object, the grasp heatmap indicative of grasp areas of the object; and select the grasp location as a grasp area of the object, and the processor-executable instructions or data which cause the at least one processor to select the grasp primitive may cause the at least one processor to select the grasp primitive based on the at least one three-dimensional shape in the platonic representation of the object which at least approximately corresponds to the grasp location.

The processor executable instructions which cause the at least one sensor to capture sensor data about the object may cause the at least one sensor to capture sensor data selected from a group of sensor data consisting of: image data; audio data; tactile data; haptic data; actuator data indicating a state of a corresponding actuator; inertial data; proprioceptive data indicating a position, movement, or force applied for a corresponding actuatable member of the robot body; and position data about at least one joint or appendage of the robot body.

The processor-executable instructions or data may further cause the at least one sensor to collect further sensor data indicative of engagement between the end effector and the object, as the end effector is controlled to apply the grasp primitive; the processor executable instructions which cause the at least one processor to control the end effector to apply the grasp primitive to grasp the object may further cause the at least one processor to adjust control of the end effector based on the further sensor data. The further sensor data may be indicative of engagement between the end effector and the object being different from expected engagement between the end effector and the at least one three-dimensional shape upon which the selection of the grasp primitive is at least partially based. The processor-executable instructions or data which cause the at least one processor to adjust control of the end effector based on the further sensor data may cause the at least one processor to optimize actuation at least one member of the end effector to increase grasp effectiveness.

The robot body may carry the at least one processor; and the processor-executable instructions or data which cause the processor-based system to capture the sensor data, access the platonic representation of the object, select a grasp primitive, and control the end effector, may be executed at the robot body.

The robot body may carry the at least one sensor; a remote device remote from the robot body may include the at least one processor; the processor-executable instructions or data may further cause the processor-based system to transmit, by a communication interface between the robot body and the remote device, the sensor data from the robot body to the remote device; and the processor-executable instructions or data which cause the at least one processor to control the end effector may cause the at least one processor to prepare and send control instructions to the robot body via the communication interface.

The robot body may carry the at least one sensor, a first processor of the at least one processor, and a first non-transitory processor-readable storage medium of the at least one non-transitory processor-readable storage medium; a remote device remote from the robot body may include a second processor of the at least one processor and a second non-transitory processor-readable storage medium of the at least one non-transitory processor-readable storage medium; the processor-executable instructions or data may include first processor-executable instructions or data stored at the first non-transitory processor-readable storage medium that when executed cause the processor-based system to: capture the sensor data by the at least one sensor; transmit, via a communication interface between the robot body and the remote device, the sensor data from the robot body to the remote device; and control, by the first at least one processor, the end effector to apply the grasp primitive to grasp the object; and the processor-executable instructions or data may include second processor-executable instructions or data stored at the second non-transitory processor-readable storage medium that when executed cause the processor-based system to: access, from the second non-transitory processor-readable storage medium, the platonic representation of the object; select, by the second processor, the grasp primitive; and transmit, via the communication interface, data indicating the grasp primitive and the platonic representation of the object to the robot body.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIGS. 1, 2, and 3 are respective illustrative diagrams of exemplary robot systems comprising various features and components described throughout the present systems, methods, and control modules.

FIGS. 4A, 4B, and 4C are respective views of a hand-shaped member having tactile or haptic sensors thereon.

FIG. 5A is a side view of a hammer. FIG. 5B is a side view of a platonic representation of the hammer in FIG. 5A.

FIGS. 6, 7, 8A, 8B, 9A, 9B, 9C, 10, 11, and 12 are isometric views of exemplary three-dimensional geometric shapes, in accordance with at least ten illustrated examples.

FIG. 13A is a side view of a knife. FIG. 13B is a side view of a platonic representation of the knife in FIG. 13A.

FIGS. 14, 15, 16, 17, 18, 19, and 20 are views of three-dimensional shapes being grasped by an end effector, in accordance with at least seven illustrated examples.

FIG. 21 is a flowchart diagram which illustrates a method of operating a robot system, in accordance with one exemplary illustrated implementation.

FIG. 22A is a scene view which illustrates an exemplary environment in which a robot body is positioned. FIG. 22B is a scene view of a virtual environment model of the environment shown in FIG. 22A.

FIG. 23 is a flowchart diagram which illustrates a method of generating a platonic representation, in accordance with one exemplary illustrated implementation.

FIG. 24A is an isometric view of a book. FIG. 24B is an isometric view of a platonic representation of the book in FIG. 24A.

FIG. 25A is a front view of a paddle. FIGS. 25B, 25C, 25D, 25E, and 25F are front views of generation of a platonic representation of the paddle shown in FIG. 25A.

FIGS. 26A and 26B are side views of a platonic representation of a knife being grasped in different locations, in accordance with at least two illustrated examples.

FIG. 27 is a front view of a platonic representation of a paddle being grasped in different locations, in accordance with at least four illustrated examples.

FIG. 28 is a front view of a platonic representation of a paddle and corresponding heatmap, in accordance with at least one illustrated example.

FIG. 29A is a side view of a knife handle being grasped according to a platonic representation. FIG. 29B is a side view of grasping of the knife handle of FIG. 29A being adjusted.

FIG. 30A is a front view of a paddle grip being grasped according to a platonic representation. FIG. 30B is a side view of grasping of the paddle grip of FIG. 30A being adjusted.

### DETAILED DESCRIPTION

The following description sets forth specific details in order to illustrate and provide an understanding of the various implementations and embodiments of the present systems, methods, and control modules. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, methods, and control modules.

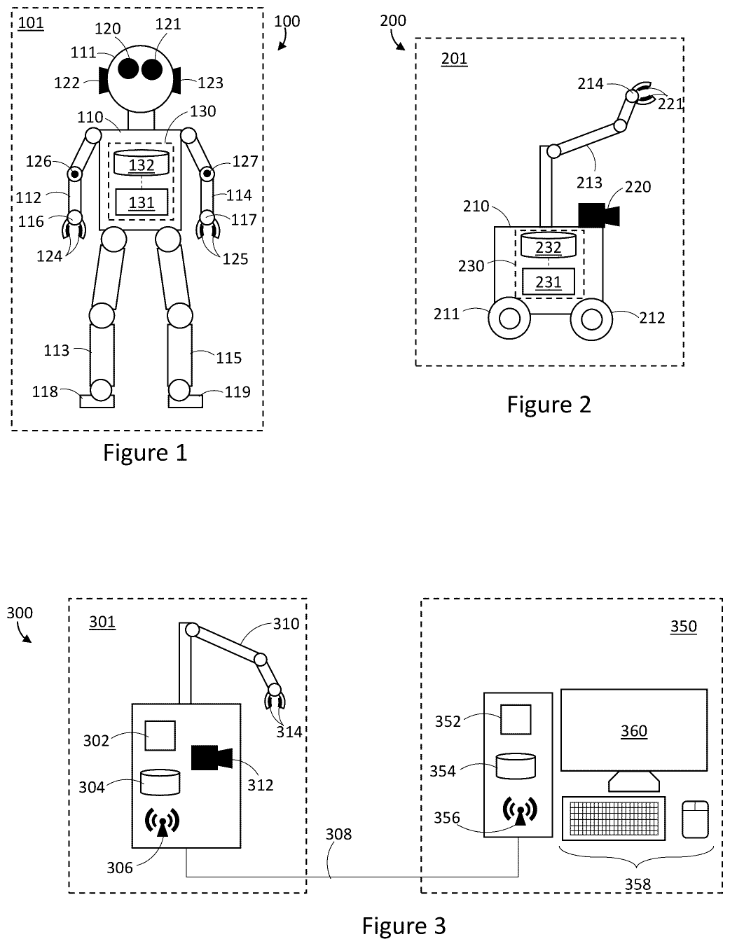

FIG. 1 is a front view of an exemplary robot system 100 in accordance with one implementation. In the illustrated example, robot system 100 includes a robot body 101 that is designed to approximate human anatomy, including a torso 110 coupled to a plurality of components including head 111, right arm 112, right leg 113, left arm 114, left leg 115, right end-effector 116, left end-effector 117, right foot 118, and left foot 119, which approximate anatomical features. More or fewer anatomical features could be included as appropriate for a given application. Further, how closely a robot approximates human anatomy can also be selected as appropriate for a given application.

Each of components 110, 111, 112, 113, 114, 115, 116, 117, 118, and 119 can be actuatable relative to other components. Any of these components which is actuatable relative to other components can be called an actuatable member. Actuators, motors, or other movement devices can couple together actuatable components. Driving said actuators, motors, or other movement driving mechanism causes actuation of the actuatable components. For example, rigid limbs in a humanoid robot can be coupled by motorized joints, where actuation of the rigid limbs is achieved by driving movement in the motorized joints.

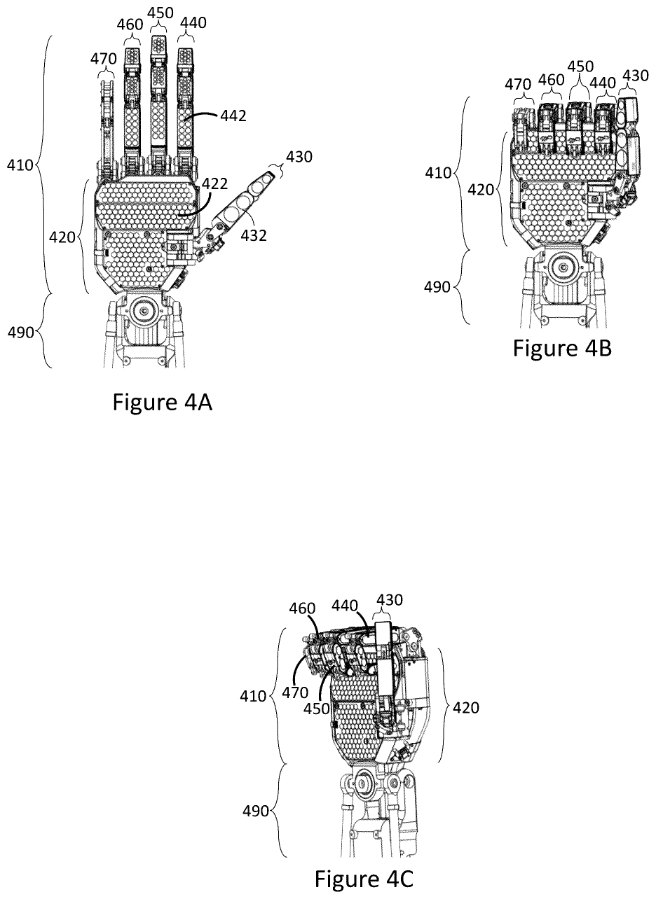

End effectors 116 and 117 are shown in FIG. 1 as grippers, but any end effector could be used as appropriate for a given application. FIGS. 4A, 4B, and 4C discussed later illustrate an exemplary case where the end effectors can be hand-shaped members.

Right leg 113 and right foot 118 can together be considered as a support member and/or a locomotion member, in that the leg 113 and foot 118 together can support robot body 101 in place, or can move in order to move robot body 101 in an environment (i.e. cause robot body 101 to engage in locomotion). Left leg 115 and left foot 119 can similarly be considered as a support member and/or a locomotion member. Legs 113 and 115, and feet 118 and 119 are exemplary support and/or locomotion members, and could be substituted with any support members or locomotion members as appropriate for a given application. For example, FIG. 2 discussed later illustrates wheels as exemplary locomotion members instead of legs and feet.

Robot system 100 in FIG. 1 includes a robot body 101 that closely approximates human anatomy, such that input to or control of robot system 100 can be provided by an operator performing an action, to be replicated by the robot body 101 (e.g. via a tele-operation suit or equipment). In some implementations, it is possible to even more closely approximate human anatomy, such as by inclusion of actuatable components in a face on the head 111 of robot body 101, or with more detailed design of hands or feet of robot body 101, as non-limiting examples. However, in other implementations a complete approximation of the human anatomy is not required, and a robot body may only approximate a portion of human anatomy. As non-limiting examples, only an arm of human anatomy, only a head or face of human anatomy; or only a leg of human anatomy could be approximated.

Robot system 100 is also shown as including sensors 120, 121, 122, 123, 124, 125, 126, and 127 which collect context data representing an environment of robot body 101. In the example, sensors 120 and 121 are image sensors (e.g. cameras) that capture visual data representing an environment of robot body 101. Although two image sensors 120 and 121 are illustrated, more or fewer image sensors could be included. Also in the example, sensors 122 and 123 are audio sensors (e.g. microphones) that capture audio data representing an environment of robot body 101. Although two audio sensors 122 and 123 are illustrated, more or fewer audio sensors could be included. In the example, haptic (tactile) sensors 124 are included on end effector 116, and haptic (tactile) sensors 125 are included on end effector 117. Haptic sensors 124 and 125 can capture haptic data (or tactile data) when objects in an environment are touched or grasped by end effectors 116 or 117. Haptic or tactile sensors could also be included on other areas or surfaces of robot body 101. Also in the example, proprioceptive sensor 126 is included in arm 112, and proprioceptive sensor 127 is included in arm 114. Proprioceptive sensors can capture proprioceptive data, which can include the position(s) of one or more actuatable member(s) and/or force-related aspects of touch, such as force-feedback, resilience, or weight of an element, as could be measured by a torque or force sensor (acting as a proprioceptive sensor) of an actuatable member which causes touching of the element. “Proprioceptive” aspects of touch which can also be measured by a proprioceptive sensor can also include kinesthesia, motion, rotation, or inertial effects experienced when a member of a robot touches an element, as can be measured by sensors such as an Inertial measurement unit (IMU), and accelerometer, a gyroscope, or any other appropriate sensor (acting as a proprioceptive sensor). Generally, robot system 100 (or any other robot system discussed herein) can also includes sensors such an actuator sensor which captures actuator data indicating a state of a corresponding actuator, an inertial sensor which captures inertial data, or a position encoder which captures position data about at least one joint or appendage.

Several types of sensors are illustrated in the example of FIG. 1, though more or fewer sensor types could be included. For example, audio sensors may not be included. As another example, other sensor types, such as accelerometers, inertial sensors, gyroscopes, temperature sensors, humidity sensors, pressure sensor, radiation sensors, or any other appropriate types of sensors could be included. Further, although sensors 120 and 121 are shown as approximating human eyes, and sensors 122 and 123 are shown as approximating human ears, sensors 120, 121, 122, and 123 could be positioned in any appropriate locations and have any appropriate shape.

Throughout this disclosure, reference is made to “haptic” sensors, “haptic” feedback, and “haptic” data. Herein, “haptic” is intended to encompass all forms of touch, physical contact, or feedback. This can include (and be limited to, if appropriate) “tactile” concepts, such as texture or feel as can be measured by a tactile sensor. Unless context dictates otherwise, “haptic” can also encompass “proprioceptive” aspects of touch.

Robot system 100 is also illustrated as including at least one processor 131, communicatively coupled to at least one non-transitory processor-readable storage medium 132. The at least one processor 131 can control actuation of components 110, 111, 112, 113, 114, 115, 116, 117, 118, and 119; can receive and process data from sensors 120, 121, 122, 123, 124, 125, 126, and 127; can determine context of the robot body 101, and can determine transformation trajectories, among other possibilities. The at least one non-transitory processor-readable storage medium 132 can have processor-executable instructions or data stored thereon, which when executed by the at least one processor 131 can cause robot system 100 to perform any of the methods discussed herein. Further, the at least one non-transitory processor-readable storage medium 132 can store sensor data, classifiers, reusable work primitives, grasp primitives, three-dimensional shape models, platonic representations, or any other data as appropriate for a given application. The at least one processor 131 and the at least one processor-readable storage medium 132 together can be considered as components of a “robot controller” 130, in that they control operation of robot system 100 in some capacity. While the at least one processor 131 and the at least one processor-readable storage medium 132 can perform all of the respective functions described in this paragraph, this is not necessarily the case, and the “robot controller” 130 can be or further include components that are remote from robot body 101. In particular, certain functions can be performed by at least one processor or at least one non-transitory processor-readable storage medium remote from robot body 101, as discussed later with reference to FIG. 3.

In some implementations, it is possible for a robot body to not approximate human anatomy. FIG. 2 is an elevated side view of a robot system 200 including a robot body 201 which does not approximate human anatomy. Robot body 201 includes a base 210, having actuatable components 211, 212, 213, and 214 coupled thereto. In the example, actuatable components 211 and 212 are wheels (locomotion members) which support robot body 201, and provide movement or locomotion capabilities to the robot body 201. Actuatable components 213 and 214 are a support arm and an end effector, respectively. The description for end effectors 116 and 117 in FIG. 1 is applicable to end effector 214 in FIG. 2. End effector 214 can also take other forms, such as a hand-shaped member as discussed later with reference to FIGS. 4A, 4B, and 4C. In other examples, other actuatable components could be included.

Robot system 200 also includes sensor 220, which is illustrated as an image sensor. Robot system 200 also includes a haptic sensor 221 positioned on end effector 214. The description pertaining to sensors 120, 121, 122, 123, 124, 125, 126, and 127 in FIG. 1 is also applicable to sensors 220 and 221 in FIG. 2 (and is applicable to inclusion of sensors in robot bodies in general). End effector 214 can be used to touch, grasp, or manipulate objects in an environment. Further, any number of end effectors could be included in robot system 200 as appropriate for a given application or implementation.

Robot system 200 is also illustrated as including a local or on-board robot controller 230 comprising at least one processor 231 communicatively coupled to at least one non-transitory processor-readable storage medium 232. The at least one processor 231 can control actuation of components 210, 211, 212, 213, and 214; can receive and process data from sensors 220 and 221; and can determine context of the robot body 201 and can determine transformation trajectories, among other possibilities. The at least one non-transitory processor-readable storage medium 232 can store processor-executable instructions or data that, when executed by the at least one processor 231, can cause robot body 201 to perform any of the methods discussed herein. Further, the at least one processor-readable storage medium 232 can store sensor data, classifiers, reusable work primitive, grasp primitives, three-dimensional shape models, platonic representations, or any other data as appropriate for a given application.

FIG. 3 is a schematic diagram illustrating components of a robot system 300 comprising a robot body 301 and a physically separate remote device 350 in accordance with the present robots and methods.

Robot body 301 is shown as including at least one local or on-board processor 302, a non-transitory processor-readable storage medium 304 communicatively coupled to the at least one processor 302, a wireless communication interface 306, a wired communication interface 308, at least one actuatable component 310, at least one sensor 312, and at least one haptic sensor 314. However, certain components could be omitted or substituted, or elements could be added, as appropriate for a given application. As an example, in many implementations only one communication interface is needed, so robot body 301 may include only one of wireless communication interface 306 or wired communication interface 308. Further, any appropriate structure of at least one actuatable portion could be implemented as the actuatable component 310 (such as those shown in FIGS. 1 and 2, for example). For example, robot body 101 as described with reference to FIG. 1, or robot body 201 described with reference to FIG. 2, could be used in place of robot body 301, and communication interface 306 or communication interface 308 could be implemented therein to enable communication with remote device 350. Further still, the at least one sensor 312 and the at least one haptic sensor 314 can include any appropriate quantity or type of sensor, as discussed with reference to FIGS. 1 and 2.

Remote device 350 is shown as including at least one processor 352, at least one non-transitory processor-readable medium 354, a wireless communication interface 356, a wired communication interface 308, at least one input device 358, and an output device 360. However, certain components could be omitted or substituted, or elements could be added, as appropriate for a given application. As an example, in many implementations only one communication interface is needed, so remote device 350 may include only one of wireless communication interface 356 or wired communication interface 308. As another example, input device 358 can receive input from an operator of remote device 350, and output device 360 can provide information to the operator, but these components are not essential in all implementations. For example, remote device 350 can be a server which communicates with robot body 301, but does not require operator interaction to function. Additionally, output device 360 is illustrated as a display, but other output devices are possible, such as speakers, as a non-limiting example. Similarly, the at least one input device 358 is illustrated as a keyboard and mouse, but other input devices are possible.

In some implementations, the at least one processor 302 and the at least one processor-readable storage medium 304 together can be considered as a “robot controller”, which controls operation of robot body 301. In other implementations, the at least one processor 352 and the at least one processor-readable storage medium 354 together can be considered as a “robot controller” which controls operation of robot body 301 remotely. In yet other implementations, that at least one processor 302, the at least one processor 352, the at least one non-transitory processor-readable storage medium 304, and the at least one processor-readable storage medium 354 together can be considered as a “robot controller” (distributed across multiple devices) which controls operation of robot body 301. “Controls operation of robot body 301” refers to the robot controller's ability to provide instructions or data for operation of the robot body 301 to the robot body 301. In some implementations, such instructions could be explicit instructions which control specific actions of the robot body 301. In other implementations, such instructions or data could include broader instructions or data which guide the robot body 301 generally, where specific actions of the robot body 301 are controlled by a control unit of the robot body 301 (e.g. the at least one processor 302), which converts the broad instructions or data to specific action instructions. In some implementations, a single remote device 350 may communicatively link to and at least partially control multiple (i.e., more than one) robot bodies. That is, a single remote device 350 may serve as (at least a portion of) the respective robot controller for multiple physically separate robot bodies 301.

FIGS. 4A, 4B, and 4C illustrate an exemplary end effector 410 coupled to a member 490 of a robot body. Member 490 could be, for example, an arm of robot body 101, 201, or 301 in FIG. 1, 2, or 3. As a specific example, member 490 could correspond to arm 112 or arm 114 in robot body 101 in FIG. 1. In the illustrated example, end effector 410 is hand-shaped, to grasp, grip, handle, manipulate, touch, or release objects similar to how a human hand would. In the illustrated example, end effector 410 includes finger-shaped members 430, 440, 450, 460, and 470. Although five finger-shaped members are illustrated, any number of finger-shaped members could be included as appropriate for a given application. Finger-shaped member 430 can alternatively be referred to as a thumb-shaped member. Each of finger-shaped members 430, 440, 450, 460, and 470 are coupled to a palm-shaped member 420. Palm-shaped member 420 serves as a common member to which the finger-shaped members are coupled. In the example, each of finger-shaped members 430, 440, 450, 460, and 470 are actuatable relative to the palm-shaped member 420 at a respective joint. The finger-shaped members can also include joints at which sub-members of a given finger-shaped member are actuatable. A finger-shaped member can include any number of sub-members and joints, as appropriate for a given application.

End effector 410 in FIGS. 4A, 4B, and 4C can be referred to as a “hand-shaped member”. Similar language is used throughout this disclosure, and is sometimes abbreviated to simply “hand” for convenience.

In some implementations, the end effectors and/or hands described herein, including but not limited to hand 410, may incorporate any or all of the teachings described in U.S. patent application Ser. No. 17/491,577, U.S. patent application Ser. No. 17/749,536, U.S. Provisional Patent Application Ser. No. 63/323,897, and/or U.S. Provisional Patent Application Ser. No. 63/342,414, each of which is incorporated herein by reference in its entirety.

Although joints are not explicitly labelled in FIGS. 4A, 4B, and 4C to avoid clutter, the location of such joints can be understood based on the different configurations of end-effector 410 shown in FIGS. 4A, 4B, and 4C. FIG. 4A is a front-view which illustrates end effector 410 in an open configuration, with finger-shaped members 430, 440, 450, 460, and 470 extended from palm-shaped member 420 (for example to receive or touch an object). FIG. 4B is a front view which illustrates end effector 410 in a closed configuration, with finger-shaped members 430, 440, 450, 460, and 470 closed into palm-shaped member 420 (for example to grasp or grip an object). FIG. 4C is an isometric view which illustrates end effector 410 in the closed configuration as in FIG. 4B. The closed configuration of FIGS. 4B and 4C can also be called a contracted configuration, in that finger-shaped members 430, 440, 450, 460, and 470 are “contracted” inward relative to each other. The closed configuration can also be referred to as a grasp configuration, used for grasping an object. Notably, FIGS. 4B and 4C illustrate one particular grasp configuration, but hand 410 is capable of many different grasp configurations, as appropriate to grasp a given object. Additional grasp configurations can entail different variations of position, applied force, and orientation of any of finger-shaped members 430, 440, 450, 460, and 470. Further, a given grasp configuration need not involve grasping an object with all of finger-shaped members 430, 440, 450, 460, and 470; some grasp configurations may use only a limited subset of finger-shaped members to grasp an object. Several exemplary, non-limiting, grasp configurations are discussed later with reference to FIGS. 14, 15, 16, 17, 18, 19, and 20.

Additionally, FIGS. 4A, 4B, and 4C illustrate a plurality of tactile sensors 422, 432, and 442 on respective palm-shaped member 420 and finger-shaped members 430 and 440. Similar tactile sensors are optionally included on finger-shaped members 450 and 460 which are not labelled to avoid clutter. Finger-shaped member 470 is illustrated without tactile sensors thereon, which is indicative that in some implementations a hand-shaped member may be only partially covered by tactile sensors (although full cover by tactile sensors is possible in other implementations). Such tactile sensors can collect tactile data. Further, these “tactile” sensors can also be referred to as “haptic” sensors, in that they collect data relating to touch, which is included in haptic data as discussed earlier.

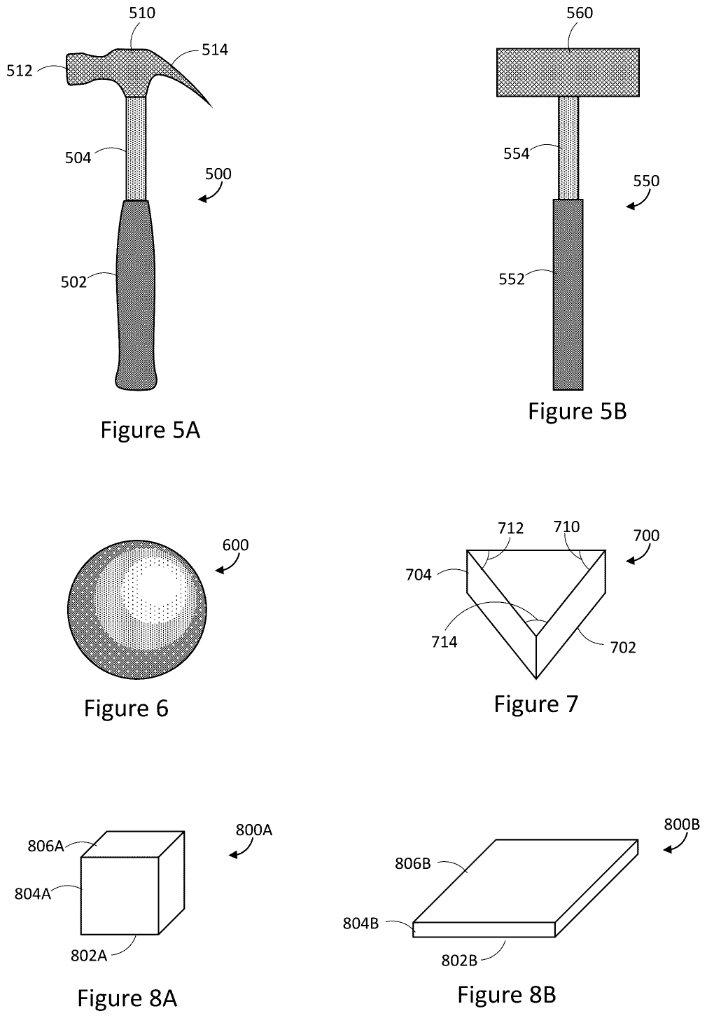

Throughout this disclosure, reference is made to “platonic representations” of objects. The term “platonic” derives from Plato's theory of forms. Generally, a platonic representation of an object is an approximation of the object, wherein the object is represented by one or more geometric shapes. Such a platonic representation can be used to select ways to grasp objects, by association of particular geometric shapes with particular grasp primitives suitable for grasping the geometric shapes. Exemplary platonic representations and geometric shapes are discussed below with reference to FIGS. 5A, 5B, 6, 7, 8A, 8A, 9A, 9B, 9C, 10, 11, 12, 13A, 13B, 25A, 25B, 25C, 25D, 25E, and 25F. Grasp primitives are discussed in more detail later with reference to FIGS. 14, 15, 16, 17, 18, 19, and 20.

FIG. 5A is a side-view of a hammer 500. Hammer 500 includes a handle 502, a head 510, and a shaft 504 which connects handle 502 to head 510. Hammer 500 is a claw-type hammer, where head 510 includes a strike region 512 and a claw region 514. Hammer 500 is merely an exemplary illustration of one object (of one object type). The discussion applies to any appropriate object or type of object.

FIG. 5B is a side-view of a platonic representation 550 of hammer 500. In platonic representation 550, handle 502 is represented by cylinder 552, shaft 504 is represented by cylinder 554, and head 510 is represented by cylinder 560. As is evident in the figures, platonic representation 550 is an approximation of hammer 500 in that not all subtleties and details of hammer 500 are represented in platonic representation 550. For example, cylinder 560 does not separately represent strike region 512 and claw region 514 of head 510, but rather is a basic representation of head 510 as a whole. As another example, cylinder 552 does not fully represent subtle curves and ergonomic shaping of handle 502. Though some detail is not represented in platonic representation 550, this advantageously reduces complexity in determining an appropriate way to grasp hammer 500 based on platonic representation 560.

The level of detail in a given platonic representation can vary as appropriate in a given application, scenario, or implementation. In the example of FIGS. 5A and 5B, platonic representation 560 could be increased in accuracy, for example by separately representing strike region 512 and claw region 514 of head 510. Further in the example of FIGS. 5A and 5B, platonic representation 560 could be decreased in accuracy (and thus increased in generality), for example by representing handle 502 and shaft 504 with a single cylinder.

Generally, a platonic representation of an object can be generated by assembling one or more geometric shape models in an appropriate manner. Several exemplary three-dimensional geometric shape models are discussed below with reference to FIGS. 6, 7, 8A, 8B, 9A, 9B, 9C, 10, 11, and 12. Such geometric shape models can be included in a library of three-dimensional geometric shapes, for selection when generating a platonic representation and/or for association with corresponding grasp primitives suitable for grasping said three-dimensional shapes. The illustrated and discussed geometric shape models are merely exemplary; more, fewer, and/or different geometric shape models could be utilized as appropriate for a given application or object.

FIG. 6 is an isometric view of a sphere 600. Shading is illustrated on sphere 600 to better illustrate the three-dimensional nature of sphere 600. A shape or size of sphere 600 can be specified or defined by a radius, diameter, or other appropriate properties thereof.

FIG. 7 is an isometric view of a triangular prism 700. A shape or size of triangular prism 700 can be specified or defined by lengths of sides thereof (e.g. length 702 of triangular faces or length 704 of rectangular faces), angles of triangular faces (e.g. angles 710, 712, and 714), or any other appropriate feature. The illustrated example shows the triangular faces as isosceles, such that angles 710, 712, and 714 are equal (and length 702 of the sides of triangular faces are equal). For this reason, each length of each triangular face is not labelled to reduce clutter. In other examples, the triangular prism can be skewed (or non-isosceles), as discussed later with reference to FIG. 12.

FIG. 8A is an isometric view of a rectangular prism 800A. A shape or size of rectangular prism 800A can be specified or defined by lengths of sides thereof (e.g. sides 802A, 804A, and 806A). In the illustrated example, sides 802A, 804A, and 806A have equal length, such that rectangular prism 800A is a square prism. However, other side lengths, shapes, or sizes are possible. As one example, FIG. 8B is an isometric view of another rectangular prism 800B, which can be specified or defined by lengths of sides thereof (e.g. sides 802B, 804B, and 806B). In the illustrated example, sides 802B and 806B are longer than side 804B, such that rectangular prism 800B has a thinner relative shape than rectangular prism 800A. Beyond these two examples, other shapes and sizes of prisms are also possible.

In some implementations, the library of three-dimensional shapes may include a single rectangular prism, which is transformed (e.g. scaled or skewed) as appropriate to approximate features of objects. In other implementations, the library of three-dimensional shapes may include a plurality of differently sized or shaped rectangular prisms, from which a particular rectangular prism can be selected and then transformed as appropriate for a given scenario. Despite being nominally similar shapes, different sizes and shapes of rectangular prisms may be suited for different grasp primitives. Different three-dimensional shape models having different size or shape can be included in the library of three-dimensional shapes, and associated with respective grasp primitives. This is discussed in more detail later.

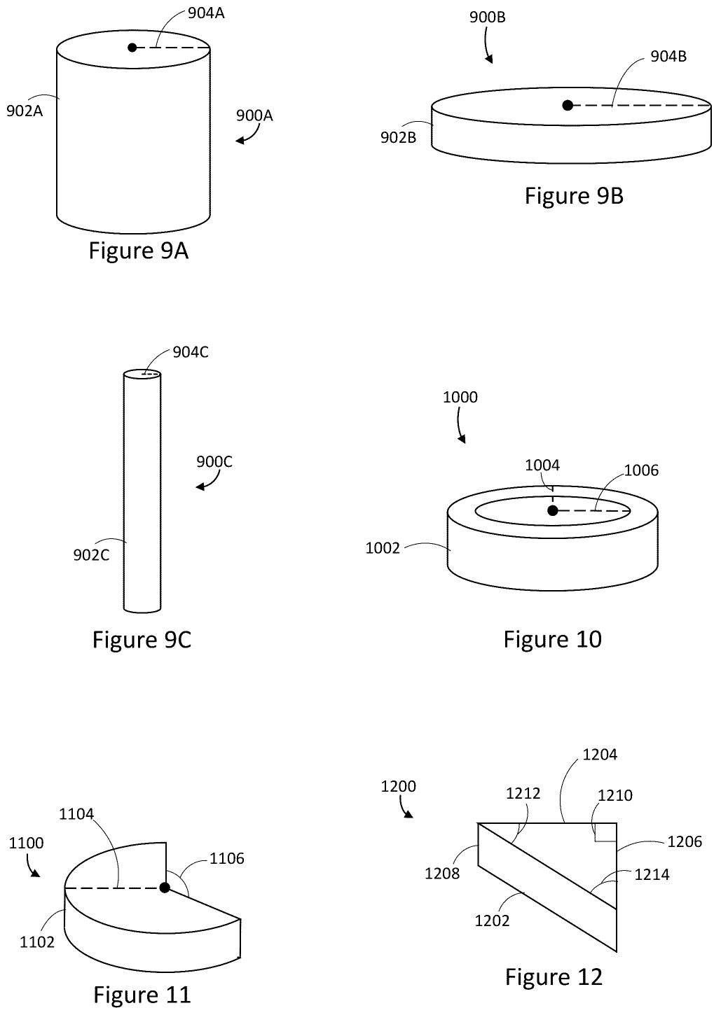

FIG. 9A is an isometric view of a cylindrical prism 900A. A shape or size of cylindrical prism 900A can be specified or defined by measurements such as length 902A and radius 904A (or a diameter or circumference thereof, for example). FIG. 9B is an isometric view of a cylindrical prism 900B which can similarly be specified or defined by measurements such as length 902B and radius 904B (or a diameter or circumference thereof, for example). FIG. 9C is an isometric view of a cylindrical prism 900C which can similarly be specified or defined by measurements such as length 902C and radius 904C (or a diameter or circumference thereof, for example). In the illustrated examples, cylindrical prism 900B has a flatter, disc-like shape compared to cylindrical prism 900A, whereas cylindrical prism 900C has an elongated rod-like shape compared to cylindrical prism 900A. Similar to as discussed with reference to rectangular prisms in FIGS. 8A and 8B, a cylindrical prism can be transformed to approximate a given features. Further, one cylindrical prism model may be included in the library of three-dimensional shapes for this purpose, or a plurality of differently shaped cylindrical prisms (which themselves can also be selected and transformed) can be included in the library of three-dimensional shapes.

FIG. 10 is an isometric view of a cylindrical shell 1000. A shape or size of cylindrical shell 1000 can be specified or defined by measurements such as length 1002, outer radius 1004, and inner radius 1006 (or appropriate diameters or circumferences, for example). Cylindrical shell 1000 could itself be included in the library of three-dimensional shapes, or could be constructed as needed based on existing three-dimensional shapes in the library (e.g. by subtracting one cylindrical prism having radius 1006 from another cylindrical prism having radius 1004).

FIG. 11 is an isometric view of a partial cylindrical prism 1100. A shape or size of partial cylindrical prism 1100 can be specified or defined by measurements such as length 1102, radius 1104, and angle 1106 (or appropriate diameter or circumference, for example). Partial cylindrical prism 1100 could itself be included in the library of three-dimensional shapes, or could be constructed as needed by subtracting a region from an existing cylindrical prism model in the library.

FIG. 12 is an isometric view of a triangular prism 1200. A shape or size of triangular prism 1200 can be specified or defined by lengths of sides thereof (e.g. lengths 1202, 1204, and 1206 of triangular faces and/or length 1208 of rectangular faces), angles of triangular faces (e.g. angles 1210, 1212, and 1214), or any other appropriate feature, similar to as discussed above regarding triangular prism 700 in FIG. 7. The illustrated example shows the triangular faces as right-angle, such that angle 1210 is 90 degrees. Similar to as discussed with reference to rectangular prisms in FIGS. 8A and 8B, a triangular prism can be transformed to approximate a given features. Further, one triangular prism model may be included in the library of three-dimensional shapes for this purpose, or a plurality of differently shaped triangular prisms (which themselves can also be selected and transformed) can be included in the library of three-dimensional shapes.

The examples of three-dimensional shapes discussed above are merely exemplary. Any of the discussed shapes could be included in a library of three-dimensional shapes, some or all of the discussed shapes could be omitted from the library, and/or other shapes could be included in the library. For example, other shapes could include any forms of prism, cube, torus, cone pyramid, -hedron (e.g. octahedron, decahedron, among others), or three-dimensional trapezoid. Further, the library could include portions of regular three-dimensional shapes, such as half-sphere, quarter-cylinder, or any other appropriate portions. Further still, in some implementations the library of three-dimensional shapes can include custom or irregular three-dimensional shapes where appropriate.

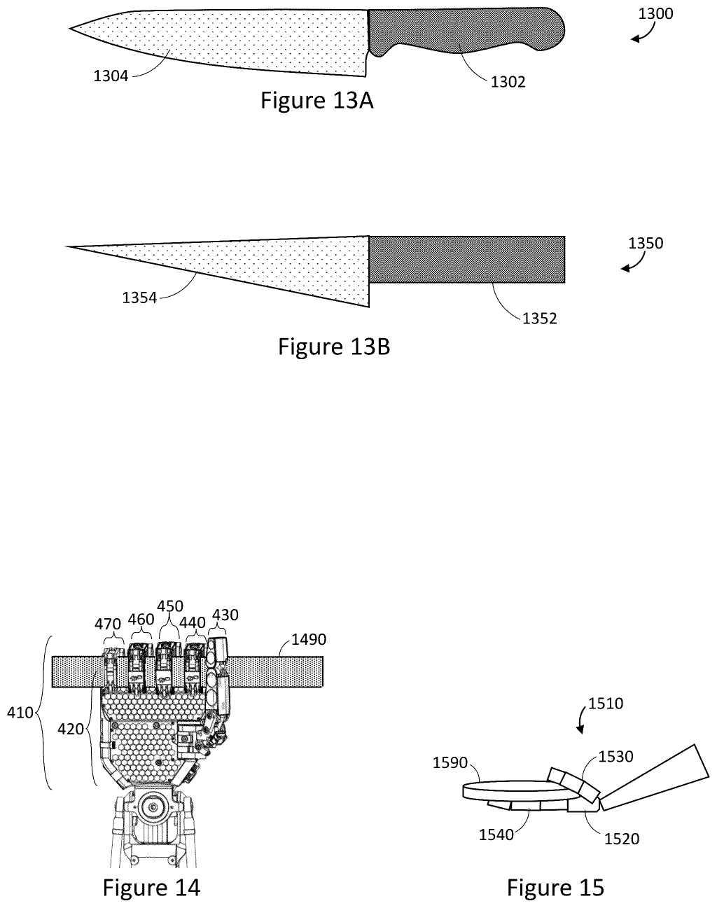

FIGS. 13A and 13B are side views which illustrate an object and a platonic representation of the object. In particular, FIG. 13A illustrates a knife 1300, having a handle 1302 and a blade 1304. As can be seen in FIG. 13A, handle 1302 and blade 1304 both have subtle curvatures and features. FIG. 13B illustrates a platonic representation 1350 of knife 1300, which includes a set of three-dimensional shapes from the library of three-dimensional shapes. In the illustrated example of FIG. 13B, platonic representation 1350 includes two three-dimensional shapes: a cylindrical (or rectangular) prism 1352 which approximates handle 1302, and a triangular prism 1354 which approximates blade 1304.

In accordance with the present robots, computer program products, and methods, platonic representations and grasping may have relevance to work objectives or workflows. In this regard, a work objective, action, task or other procedure can be deconstructed or broken down into a “workflow” comprising a set of “work primitives”, where successful completion of the work objective involves performing each work primitive in the workflow. Depending on the specific implementation, completion of a work objective may be achieved by (i.e., a workflow may comprise): i) performing a corresponding set of work primitives sequentially or in series; ii) performing a corresponding set of work primitives in parallel; or iii) performing a corresponding set of work primitives in any combination of in series and in parallel (e.g., sequentially with overlap) as suits the work objective and/or the robot performing the work objective. Thus, in some implementations work primitives may be construed as lower-level activities, steps, or sub-tasks that are performed or executed as a workflow in order to complete a higher-level work objective.

Advantageously, and in accordance with the present robots, computer program products, and methods, a catalog of “reusable” work primitives may be defined. A work primitive is reusable if it may be generically invoked, performed, employed, or applied in the completion of multiple different work objectives. For example, a reusable work primitive is one that is common to the respective workflows of multiple different work objectives. In some implementations, a reusable work primitive may include at least one variable that is defined upon or prior to invocation of the work primitive. For example, “pick up *object*” may be a reusable work primitive where the process of “picking up” may be generically performed at least semi-autonomously in furtherance of multiple different work objectives and the *object* to be picked up may be defined based on the specific work objective being pursued.

A subset of work primitives includes “grasp primitives”. Grasp primitives are generally work primitives which are pertinent to causing an end effector to grasp one or more objects. That is, a grasp primitive can comprise instructions or data which when executed, cause an end effector to carry out a grasp action specified by the grasp primitive. Grasp primitives can be reusable, as discussed for work primitives.

Work primitives are discussed in greater detail in, at least, U.S. patent application Ser. No. 17/566,589 and U.S. patent application Ser. No. 17/883,737, both of which are incorporated by reference herein in their entirety.

Objects can have many different shapes and sizes, and the way an object is grasped generally depends on the particularities of the object. To this end, a library of grasp primitives can include different grasp primitives appropriate for grasping different sizes and shapes of objects. In the context of the present disclosure, each of the three-dimensional shapes in a library of three-dimensional shapes can be associated with at least one respective grasp primitive suitable for grasping the respective three-dimensional shape. Several examples are illustrated in FIGS. 14, 15, 16, 17, 18, 19, and 20, discussed below.

FIG. 14 is a front view of a hand-shaped end effector 410 (as discussed earlier with reference to FIGS. 4A, 4B, and 4C), in a grasp configuration suitable for grasping a cylindrical prism 1490. In FIG. 14, finger-shaped members 430, 440, 450, 460, and 470 are wrapped around cylindrical prism 1490. Cylindrical prism 1490 could correspond to any of cylindrical prisms 900A, 900B, or 900C discussed earlier, or any other appropriate cylindrical prism (subject to appropriate transformations as discussed later). A grasp primitive associated with such cylindrical prism objects can include instructions or data which indicate the grasp configuration or relative positioning of elements of end effector 410 (e.g. palm-shaped member 420 and/or finger-shaped members 430, 440, 450, 460, or 470), or operations which cause end effector 410 to transform to the grasp configuration illustrated in FIG. 14.

FIG. 15 is a side view of a hand-shaped end effector 1510, in a grasp configuration suitable for grasping a cylindrical prism 1590. Cylindrical prism 1590 could correspond to any of cylindrical prisms 900A, 900B, or 900C discussed earlier, or any other appropriate cylindrical prism. Compared to cylindrical prism 1490 in FIG. 14, cylindrical prism 1590 in FIG. 15 is wide and flat. As a result, end effector 1510 is in a different grasp configuration than end effector 410 in FIG. 14. In particular, a finger-shaped member 1540 and a portion of a palm-shaped member 1520 are shown positioned underneath cylindrical prism 1590, with a thumb-shaped member 1530 positioned over a top of cylindrical prism 1590. In this way, cylindrical prism 1590 is grasped between thumb-shaped member 1530 and finger-shaped member 1540 and palm-shaped member 1520.

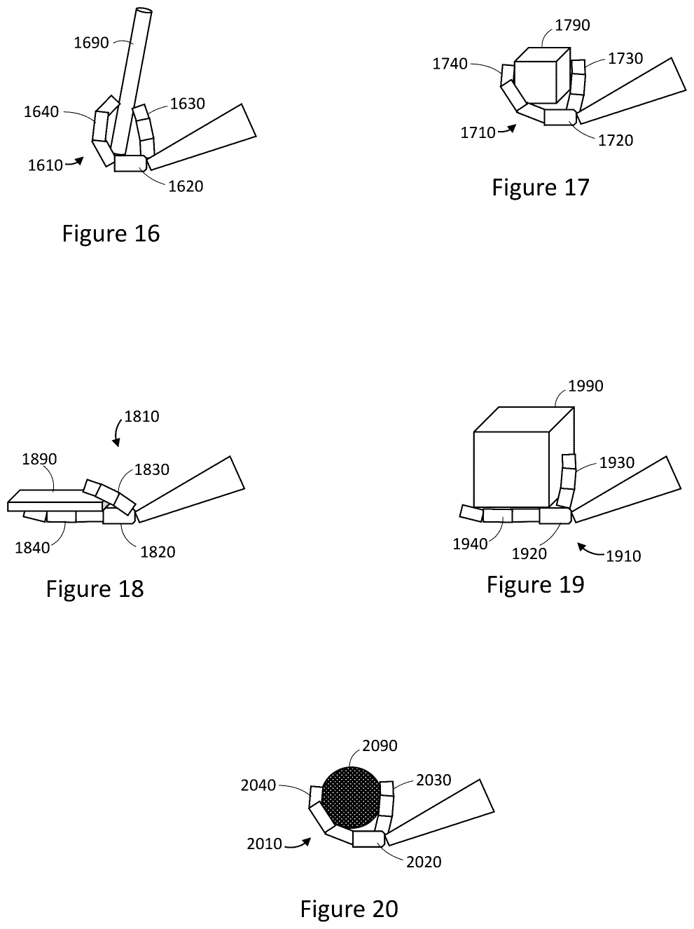

FIG. 16 is a side view of a hand-shaped end effector 1610, in a grasp configuration suitable for grasping a cylindrical prism 1690. Cylindrical prism 1690 could correspond to any of cylindrical prisms 900A, 900B, or 900C discussed earlier, or any other appropriate cylindrical prism. Compared to cylindrical prism 1490 in FIG. 14 and cylindrical prism 1590 in FIG. 15, cylindrical prism 1690 in FIG. 16 is long and slender. As a result, end effector 1610 is in a different grasp configuration than end effector 410 in FIG. 14 and end effector 1510 in FIG. 15. In particular, cylindrical prism 1690 is shown pinched between respective tips of a finger-shaped member 1640 and a thumb-shaped member 1630, which are connected by a palm-shaped member 1620.

As is evident from FIGS. 14, 15, and 16, even three-dimensional shapes of the same type (cylindrical prisms, in the examples) can have significantly varying shapes, sizes, and configurations, which are suited to being grasped in different ways.

In one implementation, a library of three-dimensional shapes can include multiple variations of certain prism types, each associated with a respected grasp primitive in a library of grasp primitives suited to that specific variation. For example, the library of three-dimensional shapes can include a “flat” cylindrical prism such as cylindrical prism 1590 associated with the grasp primitive illustrated in FIG. 15, a “slender” cylindrical prism such as cylindrical prism 1690 associated with the grasp primitive illustrated in FIG. 16, and a “tall and wide” cylindrical prism such as cylindrical prism 1490 associated with the grasp primitive illustrated in FIG. 14. These discussed shapes, labels, and grasp primitives are merely exemplary. Additional forms of the same shape type could be stored, and not all of the discussed forms of the same shape type need be stored.

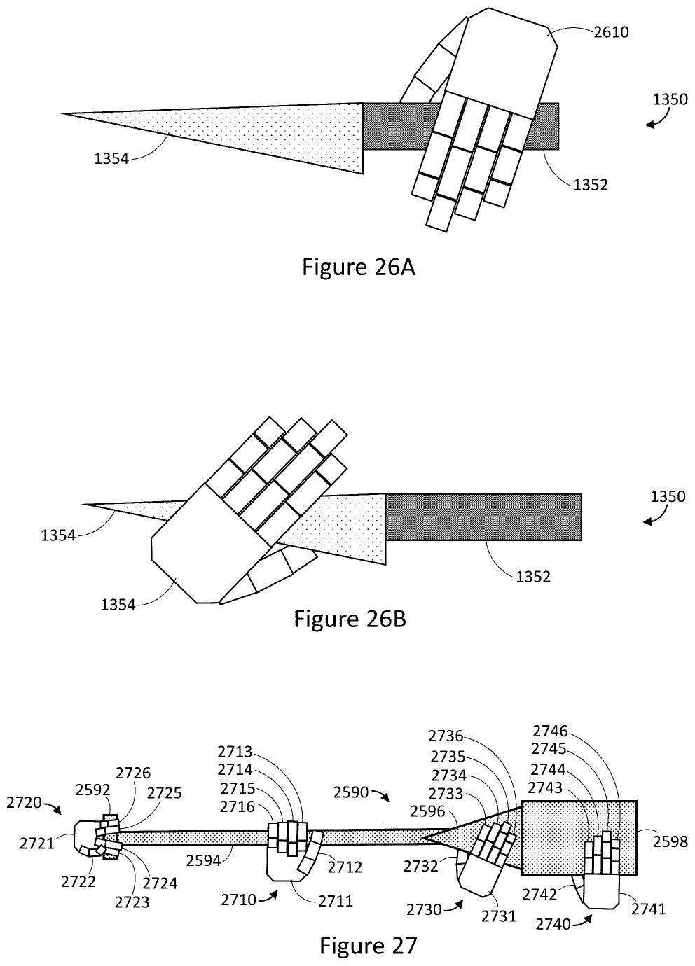

In another implementation, a library of three-dimensional shapes may include only one variation of each shape type, and each shape type can be associated with more than one grasp primitive in a library of grasp primitives suited to that specific variation. When a grasp primitive is selected for use (as discussed in more detail later with reference to at least FIGS. 26A, 26B, and 27), dimensions of the shape as transformed to approximate an object can be accounted for to select the mode appropriate grasp primitive. For example, the library of three-dimensional shapes may include only one cylindrical prism. When generating a platonic representation of an aspect of an object, the cylindrical prism model is transformed as appropriate (e.g. made “flat”, made “slender”, or made “tall and wide”, as examples). Based on the transformed shape, an appropriate grasp primitive situatable to grasp the transformed shape can be selected.

FIG. 17 is a side view of a hand-shaped end effector 1710, in a grasp configuration suitable for grasping a rectangular prism 1790. In FIG. 17, finger-shaped members 1740 and thumb shaped member 1730 are partially wrapped around rectangular prism 1790, with palm shaped member 1720 beneath. Rectangular prism 1790 could correspond to any of rectangular prisms 800A or 800B discussed earlier, or any other appropriate rectangular prism (subject to appropriate transformations as discussed later). A grasp primitive associated with such rectangular prism objects can include instructions or data which indicate the grasp configuration or relative positioning of elements of end effector 1710 (e.g. palm-shaped member 1720, thumb-shaped member 1730, finger-shaped member 1740), or operations which cause end effector 1710 to transform to the grasp configuration illustrated in FIG. 17.

FIG. 18 is a side view of a hand-shaped end effector 1810, in a grasp configuration suitable for grasping a rectangular prism 1890. Rectangular prism 1890 could correspond to any of rectangular prisms 800A or 800B discussed earlier, or any other appropriate rectangular prism. Compared to rectangular prism 1790 in FIG. 17, rectangular prism 1890 in FIG. 18 is wide and flat. As a result, end effector 1810 is in a different grasp configuration than end effector 1710 in FIG. 17. In particular, a finger-shaped member 1840 and a portion of a palm-shaped member 1820 are shown positioned underneath rectangular prism 1890, with a thumb-shaped member 1830 positioned over a top of rectangular prism 1890. In this way, rectangular prism 1890 is grasped between thumb-shaped member 1830 and finger-shaped member 1840 and palm-shaped member 1820.

FIG. 19 is a side view of a hand-shaped end effector 1910, in a grasp configuration suitable for grasping a rectangular prism 1990. Rectangular prism 1990 could correspond to any of rectangular prisms 800A or 800B discussed earlier, or any other appropriate rectangular prism. Compared to rectangular prism 1790 in FIG. 17 and rectangular prism 1890 in FIG. 18, rectangular prism 1990 in FIG. 19 is large. As a result, end effector 1910 is in a different grasp configuration than end effector 1710 in FIG. 17 and end effector 1810 in FIG. 18. In particular, rectangular prism 1990 is shown supported underneath by finger-shaped member 1940 and palm-shaped member 1920, and supported from a side by thumb-shaped member 1930.

Similar to as discussed above with reference to FIGS. 14, 15, and 16, it is evident from FIGS. 17, 18, and 19 that even three-dimensional shapes of the same type (rectangular prisms, in the examples) can have significantly varying shapes, sizes, and configurations, which are suited to being grasped in different ways. As discussed earlier, in some implementations a library of three-dimensional shape models can have multiple models for a given shape type, with a respective grasp primitive associated with each model. Also as discussed earlier, in some implementations a library of three-dimensional shape models can have a single model for a given shape type, associated with one or more grasp primitives, where a suitable grasp primitive is chosen as appropriate based on a transformed shape in a platonic representation.

As can be seen in FIGS. 15 and 18, a similar or even the same grasp primitive can be used to grab objects of similar size or profile, even if those objects are of different shape types (cylindrical prism in FIG. 15 and rectangular prism in FIG. 18). In this regard, a grasp primitive is not necessarily exclusively associated with a particular shape type or shape model, but rather can be associated with any appropriate shape types or models.

FIG. 20 is a side view of a hand-shaped end effector 2010, in a grasp configuration suitable for grasping a sphere 2090. In FIG. 20, at least one finger-shaped member 2040 and thumb shaped member 2030 are partially wrapped around sphere 2090, with palm shaped member 2020 beneath. Sphere 2090 could correspond to sphere 600 as discussed earlier, or any other appropriate sphere (subject to appropriate transformations as discussed later). A grasp primitive associated with such spherical objects can include instructions or data which indicate the grasp configuration or relative positioning of elements of end effector 2010 (e.g. palm-shaped member 2020, thumb-shaped member 2030, finger-shaped member 2040), or operations which cause end effector 2010 to transform to the grasp configuration illustrated in FIG. 20.

As can be seen in FIGS. 17 and 20, a similar or even the same grasp primitive can be used to grab objects of similar size or profile, even if those objects are of different shape types (rectangular prism in FIG. 17 and sphere in FIG. 20). FIG. 20 shows another example where a grasp primitive is not necessarily exclusively associated with a particular shape type or shape model, but rather can be associated with any appropriate shape types or models.

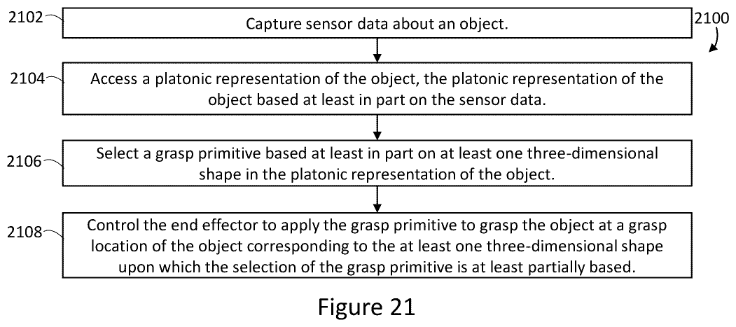

FIG. 21 is a flowchart diagram showing an exemplary method 2100 of operating a robot system. Method 2100 pertains to operation of a robot system such as those illustrated in FIGS. 1, 2, and 3, which includes a robot body having at least one end effector, at least one sensor, and a robot controller including at least one processor and at least one non-transitory processor-readable storage medium. The at least one non-transitory processor-readable storage medium can store data and/or processor-executable instructions that, when executed by the at least one processor, cause the system to perform the method. Certain acts of the method of operation of a robot system may be performed by at least one processor or processing unit (hereafter “processor”) positioned at the robot body, and communicatively coupled to a non-transitory processor-readable storage medium positioned at the robot body (such as those illustrated in FIGS. 1, 2, and 3). The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 2100 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method.

Method 2100 as illustrated includes acts 2102, 2104, 2106, and 2108, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 2102, at least one sensor of the robot system captures sensor data about an object. The at least one sensor can include any of the sensor types discussed earlier with reference to FIG. 1, 2, or 3. The object can be any object which can be perceived by the at least one sensor, and is commonly within an environment in which the robot body is positioned. Sensor data about the object refers to sensor data which in some way at least partially represents the object, such as shape, position, orientation, appearance, condition, texture, weight, or any other appropriate features. As one example, the sensor data about the object can comprise image data including at least one image including a visual representation of the object. As another example, the sensor data about the object can comprise haptic or tactile data captured by a sensor which contacts the object, or a sensor which is coupled to an element of the robot which contacts the object.

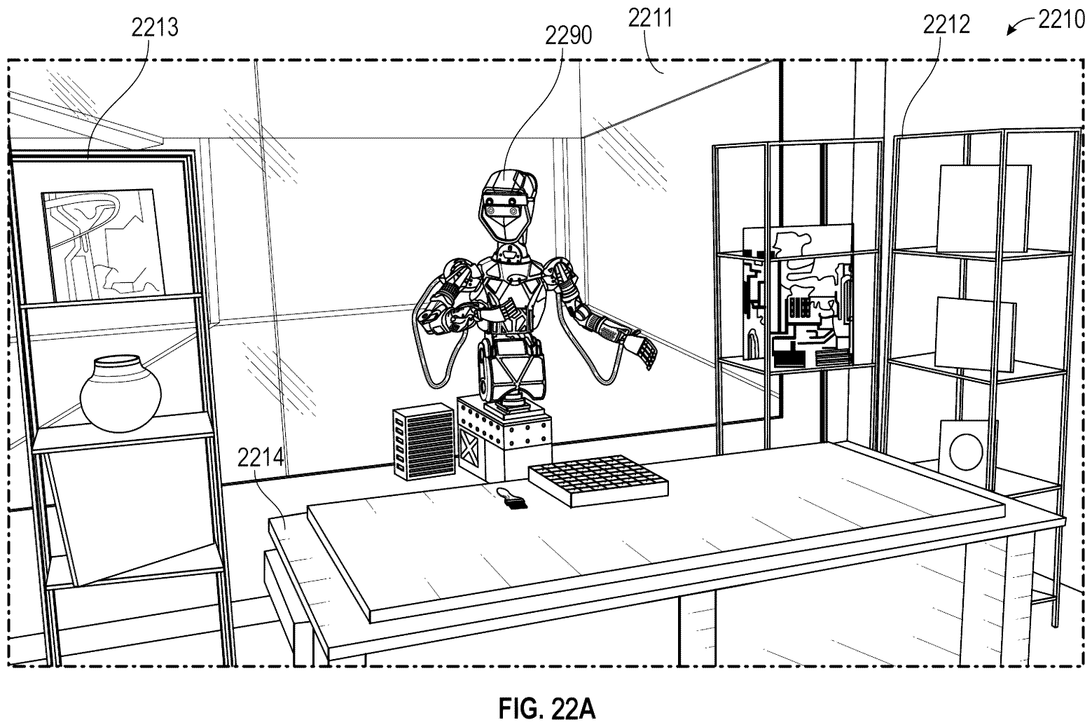

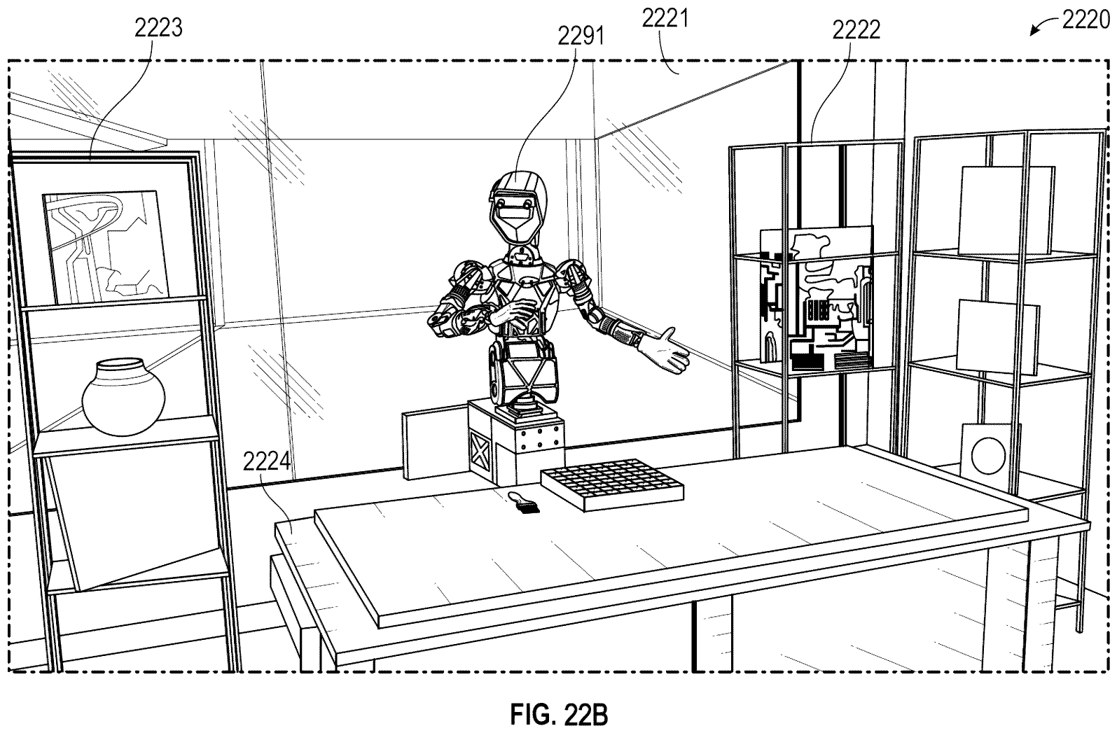

In the context of method 2100, the at least one non-transitory processor-readable storage medium of the robot system further stores a library of three-dimensional shapes and a library of grasp primitives. The stored library of three-dimensional shapes corresponds to geometric shapes which are useful to approximate features of the object, as discussed earlier with reference to FIGS. 6, 7, 8A, 8B, 9A, 9B, 9C, 10, 11, and 12. The library of grasp primitives corresponds to configurations of end effector for grasping three-dimensional shapes (or instructions or data for causing the end effector to transform to such configurations), as discussed earlier with reference to FIGS. 14, 15, 16, 17, 18, 19, and 20. At 2104, the robot controller accesses a platonic representation of the object comprising a set of at least one three-dimensional shape from the library of three-dimensional shapes. The platonic representation of the object is accessed based at least in part on the sensor data. Examples of accessing platonic representations of objects are discussed in detail later with reference to FIGS. 22A, 22B, 23, 24A, 24B, 25A, 25B, 25C, 25D, 25E, and 25F.

At 2106, the robot controller selects a grasp primitive from the library of grasp primitives, based at least in part on at least one three-dimensional shape in the platonic representation of the object. That is, the robot controller can select a grasp primitive suitable to grasp a three-dimensional shape in the platonic representation of the object. Exemplary implementations for selecting the grasp primitive are discussed later with reference to FIGS. 26A, 26B, 27, and 28.

At 2108, the robot controller controls the end effector to apply the grasp primitive to grasp the object, at a grasp location of the object corresponding to the at least one three-dimensional shape upon which the selection of the grasp primitive is at least partially based.

Method 2100 advantageously provides a means for using a finite trained data set (grasp primitives) to grasp real-world objects which can have nearly infinite permutations and varieties, by using grasp primitives associated with geometric approximations of objects in the form of platonic representations. This eases the training burden in order for the robot to be functional, and reduces the amount of instructions and data that must be stored and executed, thereby reducing burden on computational resources.

In some implementations, accessing the platonic representation of the object at 2104 comprises accessing the platonic representation from a database, as discussed below with reference to FIGS. 22A and 22B.

FIG. 22A is a scene view which illustrates an exemplary environment 2210 in which a robot body 2290 is positioned. Environment 2210 includes at least display 2211 behind robot body 2290, shelving units 2212 and 2213 to the sides of robot body 2290, a table 2214 in front of robot body 2290, and a brush 2215 on table 2214. The foregoing does not describe every feature or element illustrated in environment 2210, but rather describes some prominent features to provide insight into what is shown in FIG. 22A.

FIG. 22B is a scene view which illustrates a virtual environment model 2220 which represents environment 2210 in FIG. 22A. Environment model 2220 includes representation 2291, which is a virtual model of robot 2290 in FIG. 22A. Environment model 2220 includes representation 2221 of display 2211 behind representation 2291 of robot body 2290, representations 2222 and 2223 of shelving units 2212 and 2213 to the sides of representation 2291 of robot body 2290, representation 2224 of table 2214 in front of representation 2291 of robot body 2290, and representation 2225 of brush 2215 on representation 2224 of table 2214. Environment model 2220 can include a visually rendered representation 2291 of robot body 2290, such that when robot body 2290 is operated at least partially based on environment model 2220, robot body 2290 can be “seen” as representation 2291 in environment model 2220. Alternatively, environment model 2220 can specify representation 2291 as a spatial representation of robot body 2290 (even if not visually rendered) where elements in the environment model 2220 are specified relative to a position of representation 2291 of robot body 2290. In this way representation 2291 of robot body 2290 may not be visually “seen” as representation 2291, but locations of elements relative to the position of representation 2291 can still be understood.

FIGS. 22A and 22B visually illustrate an environment model representing an environment, and such an environment model can be constructed, generated, populated, and/or refined based on collected data. In some implementations, environment 2210 in FIG. 22A is a physical (real-world) environment comprising physical objects. In such implementations, data can be collected by physical systems or devices (e.g. by at least one image sensor of robot body 2290, or by at least one image sensor of another device or robot), and used for construction or population of environment model 2220 in FIG. 22B. In other implementations, environment 2210 in FIG. 22A is a virtual environment comprising virtual objects. In such implementations, data can be virtually “collected” by simulated systems or devices (e.g. by at least one virtual image sensor of a virtual robot body 2290, or by at least one virtual image sensor of another virtual device or virtual robot), and used for construction or population of environment model 2220 in FIG. 22B. Generating or populating an environment model of a virtual environment is useful for example in training and/or deploying an artificial intelligence. An environment model is useful for a robot body (virtual or real) to navigate and operate within an environment which the environment model represents.

As mentioned above, the objects in environment 2210 are represented by corresponding representations in environment model 2220. In some implementations, such representations can be platonic representations, as discussed earlier. That is, the representations of object in environment model 2220 can be geometric approximations of their real-world counterparts. In other implementations, multiple representations of objects can be associated with environment model 2220. That is, for a given object, there can be a high-fidelity representation intended to portray the object with high spatial accuracy, and there can be a lower-fidelity platonic representation intended to portray the object as geometric shapes, for the purposes of grasping.

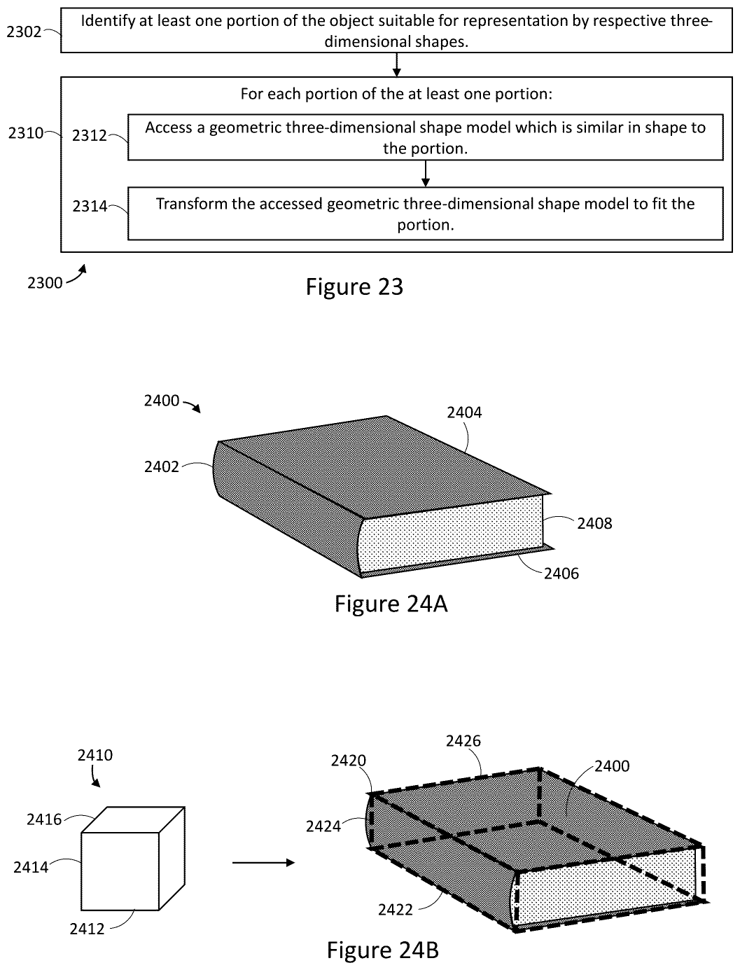

Returning to method 2100 in FIG. 21, in one exemplary implementation, in order to access the platonic representation of the object at 2104, the at least one processor can first identify the object. This identification can be based on the sensor data, and performed in any appropriate manner. As an example, an object detection model can be run on image data of the sensor data, to classify the object. As another example, a location of the object in the environment may be correlated to a location of an object representation in a virtual environment model, to identify the object representation as corresponding to the object. With the object identified, act 2104 in this exemplary implementation comprises accessing a three-dimensional model from a database, the three-dimensional model including the platonic representation of the object. For example, the at least one processor may access a representation of the object as included in a virtual environment model. As another example, the at least one processor may access a representation of the object based on classification or attributes of the object (e.g. the at least one processor may select a representation of the object as the closest available representation from a library or set of object representations). The accessed representation may itself be the platonic representation, or the platonic representation may be derived or generated based on the accessed representation. For example, the accessed representation may comprise a high-fidelity model, and the at least one processor may generate a lower-fidelity platonic model of the object based on the high-fidelity model. Generation of platonic representations can be performed for example as discussed below with reference to FIGS. 23, 24A, 24B, 25A, 25B, 25C, 25D, 25E, and 25F.

In some implementations, generation of a platonic representation of an object can be performed in advance of method 2100 in FIG. 21, and a resulting platonic representation can be made accessible to a system which executes method 2100 (e.g. by storing the platonic representation in a non-transitory processor-readable storage medium included in the system, or in a non-transitory processor-readable storage medium accessible to the system). In such cases, generation of the platonic representation can be performed by at least one processor of the system, or by a different processor or device (e.g. by at least one processor at a server or device remote from the robot system). In other implementations, generation of a platonic representation can be performed during the course of method 2100. For example, a platonic representation of an object can be generated as needed by at least one processor outside of the system, and made accessible to the system (e.g. by storing the platonic representation on a non-transitory processor-readable storage medium accessible to the system, or by sending the platonic representation to be received by a communication interface of the system). As another example, accessing at least one platonic representation of an object as in 2104 of method 2100 comprises at least one processor of the system generating the at least one platonic representation of the object.

Regardless of what processor generates the at least one platonic representation, where and when generation occurs, and how the generated at least one platonic representation is accessed, a similar generation process can be performed, by approximating the object with a set of at least one three-dimensional shapes.

FIG. 23 is a flowchart diagram showing an exemplary method 2300 of generating at least one platonic representation, by any appropriate device or system as discussed above. At least one non-transitory processor-readable storage medium can store data and/or processor-executable instructions that, when executed by at least one processor of the device or system, cause the device or system to perform the method. Unless the specific context requires otherwise, references to a processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to a robot body or other hardware which utilizes generated platonic representations. Further, method 2300 can be implemented as a control module or computer program product. Such a control module or computer program product is data-based, and comprises processor-executable instructions or data that, when the control module or computer program product is stored on a non-transitory processor-readable storage medium of a system or device, and the control module or computer program product is executed by at least one processor of the system or device, the control module or computer program product (or the processor-executable instructions or data thereof) cause the system or device to perform acts of the method.

Method 2300 as illustrated includes acts 2302 and 2312 and 2314 (grouped as 2310), though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 2302, the at least one processor identifies at least one portion of an object suitable for representation by three-dimensional shapes. The identification can be based on sensor data collected by any appropriate sensor, such as those discussed with reference to FIGS. 1, 2, and 3. For example, an object analysis model can be run on image data from an image sensor, on haptic data from a haptic sensor, or any other appropriate data.

At 2310, the at least one processor performs acts 2312 and 2314 for each portion of the identified at least one portion. At 2312, a three-dimensional shape model is accessed which is similar in shape to the portion. The three-dimensional shape model can be accessed from a library of three-dimensional shape models. FIGS. 6, 7, 8A, 8B, 9A, 9B, 9C, 10, 11, and 12 discussed earlier illustrate exemplary (non-limiting and not essential) three-dimensional shape models which could be included in such a library. At 2314, the accessed geometric three-dimensional shape model is transformed to fit the portion. For example, a size of the three-dimensional shape model can be transformed in at least one dimension to fit the size of the geometric three-dimensional model. As another alternative or additional example, a position of the geometric three-dimensional shape model is transformed to align with a position of the portion. As another alternative or additional example, the geometric three-dimensional shape model is rotated to fit the geometric model to an orientation of the portion.

FIGS. 24A and 24B illustrate an exemplary scenario where method 2300 is used.

FIG. 24A is an isometric view of a book 2400 (an object in the context of method 2300). Book 2400 includes a spine 2402 which connects a first cover 2404 and a second cover 2406. The first cover 2404 and second cover 2406 are positioned on opposite sides of pages 2408.

In accordance with act 2302 of method 2300, a portion of book 2400 which is suitable for representation by a three-dimensional shape is identified. In the illustrated example, the entirety of book 2400 is identified as one such portion. That is, in the example illustrated in FIGS. 24A and 24B, the at least one portion includes a single portion encompassing the entire book 2400.

FIG. 24B is an isometric view of book 2400, along with a rectangular prism 2410. As shown in FIG. 24B, in accordance with act 2312, rectangular prism 2410 (geometric three-dimensional shape model) is accessed which is similar in shape to book 2400. Three different sides 2412, 2414, and 2416 of the rectangular prism 2410 are shown in FIG. 24B.

Also as shown in FIG. 24B, rectangular prism is transformed to transformed prism 2420 to fit the book 2400. Sides 2412, 2414, and 2416 of rectangular prism 2400 are transformed in size to fit a size of book 2400. Further, the rectangular prism is aligned in position over book 2400. Further still, rectangular prism 2410 is rotated to the orientation of transformed prism 2420 to align with an orientation of book 2400. In particular, side 2422 of transformed prism 2420 corresponds to side 2412 of rectangular prism 2410, and is aligned with an edge of book 2400 between cover 2406 and spine 2402. Side 2424 of transformed prism 2420 corresponds to side 2414 of rectangular prism 2410, and is aligned with an edge of spine 2402 which spans between cover 2404 and cover 2406. Side 2426 of transformed prism 2420 corresponds to side 2416 of rectangular prism 2410, and is aligned with an edge of cover 2404 at the top of FIG. 24B.

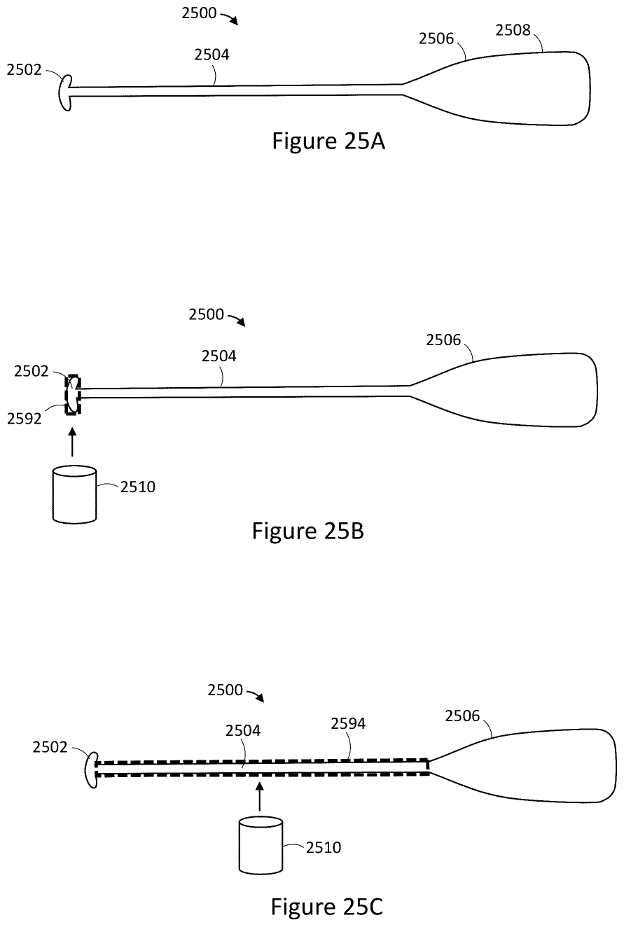

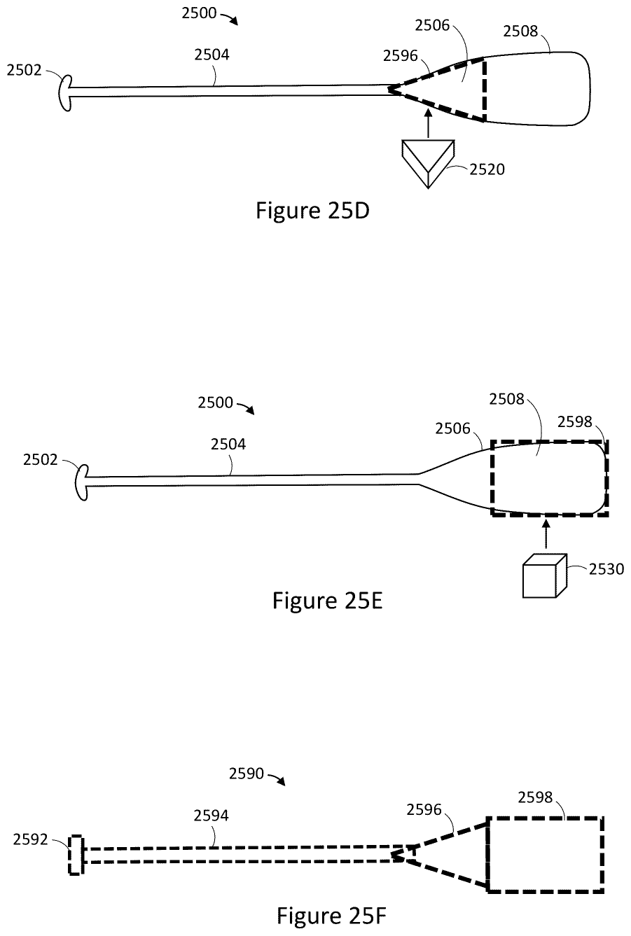

FIGS. 25A, 25B, 25C, 25D, 25E, and 25F illustrate another exemplary scenario where method 2300 is used.

FIG. 25A is a front view of paddle 2500 (e.g. such as those used for paddling a canoe or other watercraft). Paddle 2500 is shown as including at least a grip 2502 (an area intended for grasping), a blade 2508 (a portion intended for asserting in water), a shaft 2504 adjacent grip 2504, and a shoulder 2506 which extends between and connects shaft 2504 with blade 2508. In some cases, shoulder 2506 can be considered as being part of blade 2508.

In accordance with act 2302 of method 2300, portions of paddle 2500 which are suitable for representation by a three-dimensional shape are identified. In the illustrated example, each of grip 2502, shaft 2504, shoulder 2506, and blade 2508 are identified as respective portions. In accordance with 2310 of method 2300, for each of the identified portions, acts 2312 and 2314 are performed, as discussed below with reference to FIGS. 25B, 25C, 25D, and 25E.

FIG. 25B is a front view of paddle 2500 as described with reference to FIG. 25A, along with a cylindrical prism 2510. In accordance with act 2312, cylindrical prism 2510 is accessed for being similar in shape to grip 2502. In accordance with act 2314, cylindrical prism 2510 is transformed to transformed prism 2592 which represents grip 2502. Compared to cylindrical prism 2510, transformed prism 2592 has been transformed to have a smaller size and be aligned in position with grip 2502.

FIG. 25C is a front view of paddle 2500 as described with reference to FIG. 25A, along with cylindrical prism 2510. In accordance with act 2312, cylindrical prism 2510 is accessed for being similar in shape to shaft 2504. In accordance with act 2314, cylindrical prism 2510 is transformed to transformed prism 2594 which represents shaft 2504. Compared to cylindrical prism 2510, transformed prism 2594 has been transformed to have a thinner radius and longer length, be aligned in position with shaft 2504, and rotated to have an orientation of shaft 2504.

Cylindrical prism 2510 is FIGS. 25B and 25C is shown as being the same cylindrical prism, which is then transformed to fit a respective portion. However, as discussed earlier, it is also possible to access different cylindrical prisms which more closely approximate a given portion, prior to transforming said prisms.

FIG. 25D is a front view of paddle 2500 as described with reference to FIG. 25A, along with a triangular prism 2520. In accordance with act 2312 of method 2300, triangular prism 2520 is accessed for being similar in shape to shoulder 2506. In accordance with act 2314, triangular prism 2520 is transformed to transformed prism 2596 which represents shoulder 2506. Compared to triangular prism 2520, transformed prism 2596 has been transformed to be thinner and wider, to be aligned in position with shoulder 2506, and rotated to have an orientation of shoulder 2506.

FIG. 25E is a front view of paddle 2500 as described with reference to FIG. 25A, along with a rectangular prism 2530. In accordance with act 2312 of method 2300, rectangular prism 2530 is accessed for being similar in shape to blade 2508. In accordance with act 2314, rectangular prism 2530 is transformed to transformed prism 2598 which represents blade 2508. Compared to rectangular prism 2530, transformed prism 2598 has been transformed to be thinner and wider, to be aligned in position with blade 2508, and rotated to have an orientation of blade 2508.

FIG. 25F is a front view of a platonic representation 2590 of paddle 2500. In particular, in FIG. 25F, transformed prisms 2592, 2594, 2596, and 2598 are shown assembled together as an entire platonic representation of paddle 2500. This platonic representation 2590 can be stored, sent, or used in any appropriate way, such as in method 2100 of FIG. 21.

A platonic representation, once generated, can be stored, transferred, accessed, or used as a collection or array of the geometric shapes or models which make up the platonic representation. Below is an example of how a platonic representation may be stored as data, with reference to the platonic representation 550 of hammer 500 in FIGS. 5A and 5B discussed earlier.
def object(“hammer”):
parent_object_origin=[0, 0, 0]
platonic_01=cylinder( )
platonic_01.scale=[0.6. 0.5, 0.3]
platonic_01.6dof_rel=[−0.5, 0, 0, 0, 0, 0]
platonic_01.constraints=rigid_body_to_origin
platonic_02=cylinder( )
platonic_02.scale=[0.5, 0.4, 0.3]
platonic_02.6dof_rel=[0.1, 0, 0, 0, 0, 0]
platonic_02.constraints=rigid_body_to_origin
platonic_03=cylinder( )
platonic_03.scale=[0.15, 0.5, 0.4]
platonic_03.6dof_rel=[0.3, 0, 0, 0, 0, 90]
platonic_03.constraints=rigid_body_to_origin

The line “def object(‘hammer’)” defines the name of the platonic representation (or the object the platonic representation represents), and “parent_object_origin=[0, 0, 0]” defines a position of the platonic representation as a whole. The line “platonic_01=cylinder( )” defines a first shape using a cylinder model, “platonic_01.scale=[0.6, 0.5, 0.3]” defines a transformed scale of this cylinder model to achieve the first shape, and “platonic_01.6dof_rel=[−0.5, 0, 0, 0, 0, 0]” defines a position and orientation of this first shape relative to the position of the platonic representation as a whole. The line “platonic_02=cylinder( )” defines a second shape using a cylinder model, “platonic_02.scale=[0.5, 0.4, 0.3]” defines a transformed scale of this cylinder model to achieve the second shape, and “platonic_02.6dof_rel=[0.1, 0, 0, 0, 0. 0]” defines a position and orientation of this second shape relative to the position of the platonic representation as a whole. The line “platonic_03=cylinder( )” defines a third shape using a cylinder model, “platonic_03.scale=[0.15, 0.5, 0.4]” defines a transformed scale of this cylinder model to achieve the third shape, and “platonic_02.6dof_rel=[0.1, 0. 0, 0, 0, 0]” defines a position and orientation of this third shape relative to the position of the platonic representation as a whole. The lines “platonic_01.constraints=rigid_body_to_origin”, “platonic_02.constraints=rigid_body_to_origin”, and “platonic_03.constraints=rigid_body_to_origin” group the first shape, second shape, and third shape as a cohesive body which forms the platonic representation.

Returning to method 2100 in FIG. 21, the method can further include selecting a grasp location of the object (that is, the processor-executable instructions can further cause the robot controller to select the grasp location of the object). This can be performed in any number of ways, non-limiting examples of which are discussed below with reference to FIGS. 26A, 26B, 27, and 28.

FIG. 26A is a side view of platonic representation 1350 of knife 1300, discussed earlier with reference to FIGS. 13A and 13B. Platonic representation 1350 includes cylindrical prism 1352 which approximates handle 1302, and triangular prism 1354 which approximates blade 1304. FIG. 26A also illustrates end effector 2610 grasping cylindrical prism 1352 (representing handle 1302).

FIG. 26B, like FIG. 26A, is a side view of platonic representation 1350 of knife 1300, discussed earlier with reference to FIGS. 13A and 13B. FIG. 26B also illustrates end effector 2610. However, in FIG. 26B end effector 2610 is grasping triangular prism 1354 (representing blade 1304).

FIGS. 26A and 26B illustrate two exemplary different grasp locations for an object (knife 1302). In one exemplary implementation, to select which grasp location is appropriate, the robot controller in method 2100 can access a work objective of the robot system which is to grasp the object. Such a work objective can be provided to the robot system from an external source (such as an operator), or could be determined internally by the robot controller of the robot system. In either case, the work objective can be stored at any appropriate non-transitory processor-readable storage medium of the robot system, and accessed (e.g. retrieved) as needed. The robot controller can select the grasp location as a location of the object relevant to the work objective.

In one example, if the work objective entails using knife 1300 to cut something (e.g. to prepare vegetables or other ingredients for cooking), the robot controller can identify cylindrical prism 1352 (or handle 1302) as the grasp location, since grasping at this location is relevant to the work objective (to enable effective operation of knife 1300). In accordance with method 2100, the robot controller can then control end effector 2610 to grasp knife 1300 using a grasp primitive suitable for grasping cylindrical prism 1352 (representing handle 1302), as shown in FIG. 26A.

In another example, if the work objective entails fetching knife 1300 to provide knife 1300 to a recipient (e.g. a human or other robot), the robot controller can identify triangular prism 1354 (or blade 1304) as the grasp location, since grasping at this location is relevant to the work objective (to safely pass knife 1300 by presenting the handle 1302 to a recipient). In accordance with method 2100, the robot controller can then control end effector 2610 to grasp knife 1300 using a grasp primitive suitable for grasping triangular prism 1354 (representing blade 1304), as shown in FIG. 26B.

In another implementation, method 2100 may comprise identifying, by the robot controller based on the sensor data, at least one graspable feature of the object, and selecting one or more of the at least one graspable feature as the grasp location of the object. In this context, a graspable feature can refer to a feature intended for grasping, such as a handle, knob, protrusion, grip, or any other appropriate feature. With reference to FIG. 26A, the robot controller can identify cylindrical prism 1352 (or handle 1302) as being such a graspable feature, and consequently select cylindrical prism 1352 (or handle 1302) for grasping.

In other implementations, method 2100 of FIG. 21 may further include evaluating grasp-effectiveness for a plurality of grasp primitive-location pairs. In this context, a “grasp primitive-location pair” refers to a grasp primitive associated with a particular location of an object or platonic representation. That is, a grasp primitive-location pair refers to a particular grasp primitive being used to grasp an object or platonic representation at a particular location. In this sense, each grasp primitive-location pair is associated with a respective three-dimensional shape in the platonic representation of the object and a respective grasp primitive from the library of grasp primitives. FIG. 27 discussed below illustrates several exemplary grasp primitive-location pairs.

FIG. 27 is a front view of platonic representation 2590 of paddle 2500, as discussed earlier with reference to FIGS. 25A, 25B, 25C, 25D, 25E, and 25F, and not repeated for brevity. In contrast to FIG. 25F, platonic representation 2590 is shown in solid lines for easier viewing.

FIG. 27 shows a first end effector 2710 in a first grasp configuration (in accordance with a first grasp primitive), grasping platonic representation 2590 at a first location on cylindrical prism 2594 (representing shaft 2504). In particular, first end effector 2710 is hand-shaped, having a palm-shaped member 2711 with a thumb-shaped member 2712 and finger-shaped members 2713, 2714, 2715, and 2716 extending therefrom. The first grasp primitive causes thumb-shaped member 2712 and finger-shaped members 2713, 2714, 2715, and 2716 to curl around cylindrical prism 2594 at the first location. This first grasp primitive and first location can together be considered as a first grasp primitive-location pair.

FIG. 27 also shows a second end effector 2720 in a second grasp configuration (in accordance with a second grasp primitive), grasping platonic representation 2590 at a second location on cylindrical prism 2592 (representing grip 2502). In particular, second end effector 2720 is hand-shaped, having a palm-shaped member 2721 with a thumb-shaped member 2722 and finger-shaped members 2723, 2724, 2725, and 2726 extending therefrom. The second grasp primitive causes thumb-shaped member 2722 and finger-shaped members 2723, 2724, 2725, and 2726 to curl around cylindrical prism 2592 at the second location, spread apart such that cylindrical prism 2594 (representing shaft 2504) fits between finger-shaped member 2724 and finger-shaped member 2725. This second grasp primitive and second location can together be considered as a second grasp primitive-location pair.

FIG. 27 also shows a third end effector 2730 in a third grasp configuration (in accordance with a third grasp primitive), grasping platonic representation 2590 at a third location on triangular prism 2596 (representing shoulder 2506). In particular, third end effector 2730 is hand-shaped, having a palm-shaped member 2731 with a thumb-shaped member 2732 and finger-shaped members 2733, 2734, 2735, and 2736 extending therefrom. The third grasp primitive causes thumb-shaped member 2732 and finger-shaped members 2733, 2734, 2735, and 2736 to pinch triangular prism 2596 therebetween at the third location. This third grasp primitive and third location can together be considered as a third grasp primitive-location pair.

FIG. 27 also shows a fourth end effector 2740 in the third grasp configuration (in accordance with a third grasp primitive), grasping platonic representation 2590 at a fourth location on rectangular prism 2598 (representing blade 2508). In particular, fourth end effector 2740 is hand-shaped, having a palm-shaped member 2741 with a thumb-shaped member 2742 and finger-shaped members 2743, 2744, 2745, and 2746 extending therefrom. The third grasp primitive causes thumb-shaped member 2742 and finger-shaped members 2743, 2744, 2745, and 2746 to pinch rectangular prism 2598 therebetween at the fourth location. This third grasp primitive and fourth location can together be considered as a fourth grasp primitive-location pair.

As evident from the above, grasp primitives and locations are not necessarily exclusive to a particular grasp primitive-location pair (although in some cases they can be). In the example of FIG. 27, the third grasp primitive is included in both the third grasp primitive-location pair and the fourth grasp primitive-location pair. Similarly, multiple different grasp primitives may be evaluated at a particular location, resulting in multiple grasp primitive-location pairs having the same location.

Grasp-effectiveness can be evaluated by any appropriate means for each grasp primitive-location pair. In one exemplary implementation, at least one processor (such as in the robot controller in the system performing method 2100) can simulate grasping of the respective three-dimensional shaped in the platonic representation of the object, by applying the respective grasp primitive at the location. Based on the simulation, a grasp-effectiveness score can be generated. Such a score could be based on, for example, amount of surface area contact between the end effector and the object, predicted friction of the grasp, resistance to movement of the grasp, or any other appropriate metric. In another exemplary implementation, grasp effectiveness for a library of grasp primitives and corresponding geometric shapes can be predetermined (e.g. by simulation at a remote device or server), and a resulting table or database provided to the robot controller. For a given grasp primitive-location pair, the robot controller can reference the table or database for grasp effectiveness of the grasp primitive and a shape at the location to be grasped.

In the example of FIG. 27, the first grasp primitive-location pair (at end effector 2710) and the second grasp primitive-location pair (at end effector 2720) may be evaluated as having relatively high grasp-effectiveness, because these grasp primitive-location pairs entail the end effector wrapping around a portion of the paddle 2500 or platonic representation 2590. On the other hand, the third grasp primitive-location pair (at end effector 2730) and the fourth grasp primitive-location pair (at end effector 2740) may be evaluated as having lower grasp-effectiveness, because these grasp primitive-location pairs entail only a pinch between finger or thumb shaped members of the end effector. However, what level of grasp effectiveness is sufficient can be adjusted as appropriate for a given application.

Once grasp-effectiveness is evaluated, the robot controller can select an appropriate grasp primitive-location pair for application in act 2108 of method 2100. In one example, the robot controller selects a grasp primitive-location pair having the highest grasp-effectiveness score, uses the location of the grasp primitive-location pair as the location in method 2100, and uses the grasp primitive of the grasp primitive-location pair as the grasp primitive in method 2100. In another exemplary implementation, the robot controller selects the grasp location in method 2100 as a location for which a grasp primitive-location pair has a grasp-effectiveness exceeding a threshold (possibly based on additional factors, such as proximity to the robot body, work objective, or any other factors). With the location selected, the robot controller then selects the grasp primitive in method 2100 as a grasp primitive in the grasp primitive-location pair having the highest grasp effectiveness for the selected location. In this way, a feasible grasp location is first selected, then the best way to grasp the location is selected.

In another implementation, method 2100 may comprise selecting grasp location based on a grasp heatmap for an object. In particular, the robot controller can access a grasp heatmap for the object to be grasped, where the grasp heatmap is indicative of grasp areas of the object. Accessing such a grasp heatmap can entail accessing the grasp heatmap as stored at a non-transitory processor-readable storage medium of the system performing method 2100, and/or by receiving or retrieving the grasp heatmap from a remote device or server, as examples.

Grasp heatmaps can be generated in any appropriate manner, by any appropriate device, and then stored at an appropriate location for access as needed. In one exemplary implementation, for a given object (or object type), image data can be captured showing at least one hand (human or robot) grasping an object at grasp locations thereof. The image data is analyzed (e.g. by a feature extraction model) to determine at least one configuration of the hand, as well as position and orientation of the object. Based on this analysis grasp locations of the object can be identified. This can be performed a plurality of times for a given object, showing different grasp locations and/or the same grasp locations. Based on this, a grasp heatmap can be generated which indicates relative frequency of grasping the object as certain locations.

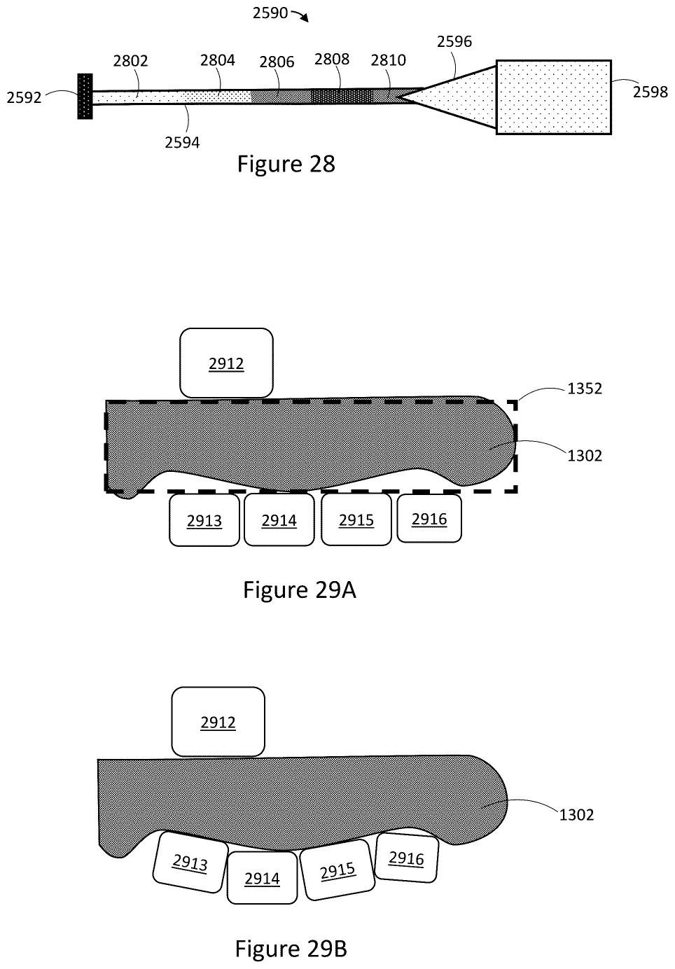

FIG. 28 is a front view of platonic representation 2590 of paddle 2500, as discussed earlier with reference to FIGS. 25A, 25B, 25C, 25D, 25E, and 25F, and not repeated for brevity. In contrast to FIG. 25F, platonic representation 2590 is shown in solid lines for easier viewing. FIG. 28 illustrates an exemplary grasp heatmap for platonic representation 2590 (representing paddle 2500). In particular, frequency of grasping at a location is shown with dark coloring representing high frequency, and light coloring representing low frequency. In this regard, cylindrical prism 2592 (representing grip 2502) is shown as being grasped very frequently (in the data based on which the grasp heatmap is generated). Regions 2808, 2806, and 2810 of cylindrical prism 2594 (representing shaft 2504) also are commonly grasped. In contrast, regions 2804 and 2802 of cylindrical prism 2594 (representing shaft 2504) see infrequent grasping, as do triangular prism 2596 (representing should 2506) and rectangular prism 2598 (representing blade 2508).

In the context of method 2100, the robot controller selects the grasp location as a grasp area of the object shown in the heatmap (i.e., a location of the object which is frequently grasped). In act 2106 of method 2100, the robot controller then selects the grasp primitive based on the three-dimensional shape in the platonic representation of the object which corresponds to the grasp location. In the example of FIG. 28, the robot controller can select cylindrical prism 2592 and/or region 2808 as the grasp location, and then select a grasp primitive suited to grasping these locations based on the shape thereof as represented in the platonic representation (in this case, cylindrical prisms).

As discussed earlier, a platonic representation is made of “platonics” or geometric three-dimensional shapes that approximate at least one portion of an object. In this regard, a grasp primitive suitable for grasping a particular platonic or three-dimensional shape may not grasp an actual object as fully intended. To address this, further sensor data can be used to refine grasping of the actual object. In the context of method 2100, the at least one sensor can capture further sensor data indicative of engagement between the end effector and the object, as the end effector is controlled to apply the grasp primitive. This further can be indicative of engagement between the end effector and the object being different from expected engagement between the end effector and the at least one three-dimensional shape upon which the selection of the grasp primitive is at least partially based. Controlling the end effector to apply the grasp primitive as in act 2108 can further comprise adjusting control of the end effector based on the further sensor data. Such adjustment of control of the end effector can include optimizing actuation of at least one member of the end effector to increase grasp effectiveness.

FIGS. 29A and 29B illustrate an example of adjusting control of the end effector based on further sensor data. FIG. 29A is a cross-section view of handle 1302 of knife 1300 discussed with reference to FIG. 13A, and of cylindrical prism 1352 representing handle 1302 as discussed with reference to FIG. 13B. FIG. 29A also shows cross-sections of a thumb-shaped member 2912 and finger-shaped members 2913, 2914, 2915, and 2916 grasping cylindrical prism 1352. As can be seen in FIG. 29A, finger-shaped members 2913, 2915, and 2916, while in an expected position relative to cylindrical prism 1352, are not in contact with handle 1302, and thus do not contribute to effectively grasping handle 1302. To ascertain and address this, further sensor data can be captured. In one example, the further sensor data can include tactile data captured by tactile sensors on surfaces of member 2912, 2913, 2914, 2915, and 2916 (such as sensors 124, 125, 221, or 314 shown in FIGS. 1, 2, and 3, or sensors 422, 432, and 442 shown in FIG. 4A). In another example, the further sensor data can include haptic or proprioceptive data captured by haptic or proprioceptive sensors which measure feedback (e.g. force feedback) on members 2912, 2913, 2914, 2915, and 2916. In yet another example, the further sensor data can include image data captured by at least one image sensor which indicates positioning of members 2912, 2913, 2914, 2915, and 2916 relative to handle 1302. Any such further sensor data can indicate that thumb-shaped member 2912 and finger-shaped member 2914 are in contact with handle 1302, whereas finger-shaped members 2913, 2915, and 2916 are not. In response to this data, control of the end effector can be adjusted, as shown in FIG. 29B.

FIG. 29B is a cross-section view of handle 1302 of knife 1300 discussed with reference to FIG. 13A. FIG. 29B also shows cross-sections of a thumb-shaped member 2912 and finger-shaped members 2913, 2914, 2915, and 2916 grasping handle 1302. Based on the further sensor data captured as discussed with reference to FIG. 29A, the robot controller which controls the end effector can further control members 2913, 2915, and 2916 to grasp tighter (e.g. move further inwards) until handle 1302 is grasped. In this way, the grasp primitive can be adjusted as appropriate to optimize grasp effectiveness when grasping a real object.

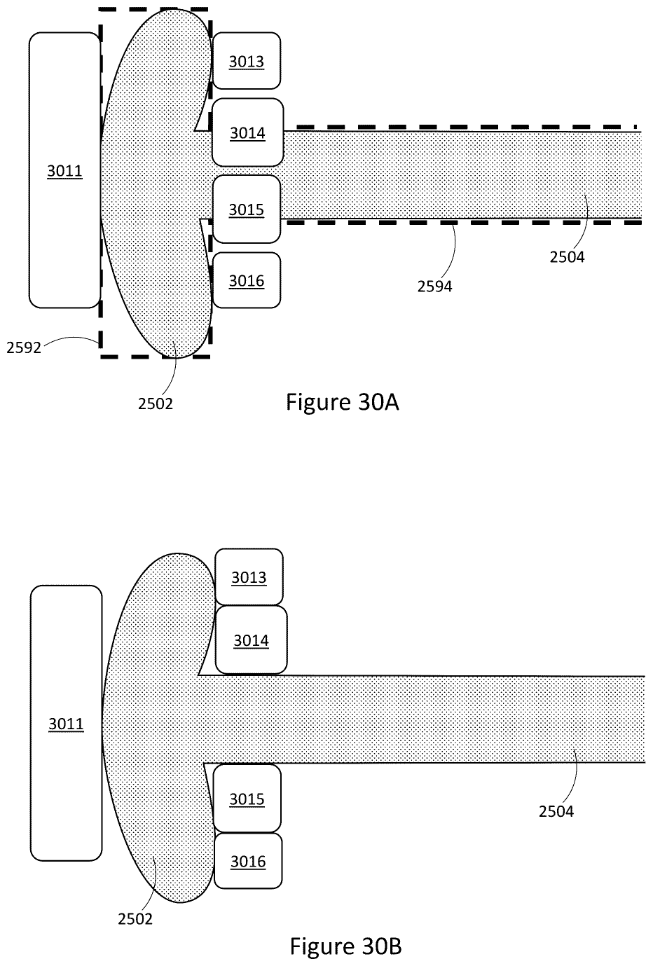

FIGS. 30A and 30B illustrate another example of adjusting control of the end effector based on further sensor data. FIG. 30A is a cross-section view of grip 2502 and a portion of shaft 2504 of paddle 2500 discussed with reference to FIG. 25A, and of cylindrical prism 2592 representing grip 2502 and cylindrical prism 2594 representing shaft 2504 as discussed with reference to FIGS. 25B, 25C, and 25F. FIG. 30A also shows cross-sections of a palm-shaped member 3011 and finger-shaped members 3013, 3014, 3015, and 3016 of an end effector in a grasp configuration around cylindrical prism 2592. As can be seen in FIG. 30A, finger-shaped members 3014 and 3015, while in an expected position relative to cylindrical prism 2592, are overlapping with shaft 2504, and thus will collide with shaft 2504 when the end effector is controlled to grasp grip 2502. To ascertain and address this, further sensor data can be captured. In one example, the further sensor data can include tactile data captured by tactile sensors on surfaces of members 3011, 3013, 3014, 3015, and 3016 (such as sensors 124, 125, 221, or 314 shown in FIGS. 1, 2, and 3 or sensors 422, 432, and 442 shown in FIG. 4A). In another example, the further sensor data can include haptic or proprioceptive data captured by haptic or proprioceptive sensors which measure feedback (e.g. force feedback) on members 3011, 3013, 3014, 3015, and 3016. In yet another example, the further sensor data can include image data captured by at least one image sensor which indicates positioning of members 3011, 3013, 3014, 3015, and 3016 relative to grip 2502 and shaft 2504. Any such further sensor data can indicate that finger-shaped members 3014 and 3015 collide with shaft 2504 in an undesired or unintended manner. In response to this data, control of the end effector can be adjusted, as shown in FIG. 30B.

FIG. 30B is a cross-section view of grip 2502 and a portion of shaft 2504 of paddle 2500 discussed with reference to FIG. 25A. FIG. 30B also shows cross-sections of a palm-shaped member 3011 and finger-shaped members 3013, 3014, 3015, and 3016 of an end effector in a grasp configuration around grip 2502. Based on the further sensor data captured as discussed with reference to FIG. 30A, the robot controller which controls the end effector can further control members 3013, 3014, 3015, and 3016 to, in response to collision with shaft 2504, open and expand, and then close again to adjust the grasp configuration by which grips 2502 is grasped. This can been seen in FIG. 30B where members 3013, 3014, 3015, and 3016 are spread apart such that shaft 2504 fits between finger-shaped members 3014 and 3015. In this way, the grasp primitive can be adjusted as appropriate to optimize grasp effectiveness when grasping a real object.

Various exemplary methods of operation of a robot system are described herein, including at least method 2100 in FIG. 21 and method 2300 in FIG. 23. As discussed earlier, a method of operation of a robot system is a method in which at least some, if not all, of the various acts are performed by the robot system. For example, certain acts of a method of operation of a robot body may be performed by at least one processor or processing unit (hereafter “processor”) of the robot body communicatively coupled to a non-transitory processor-readable storage medium of the robot body and, in some implementations, certain acts of a method of operation of a robot system may be performed by peripheral components of the robot body that are communicatively coupled to the at least one processor, such as one or more physically actuatable components (e.g., arms, legs, end effectors, grippers, hands), one or more sensors (e.g., optical sensors, audio sensors, tactile sensors, haptic sensors), mobility systems (e.g., wheels, legs), communications and networking hardware (e.g., receivers, transmitters, transceivers), and so on. The non-transitory processor-readable storage medium of the robot body may store data (including, e.g., at least one library of reusable work primitives, grasp primitives, three-dimensional geometric shapes, platonic representations) and/or processor-executable instructions that, when executed by the at least one processor, cause the robot body to perform the method and/or cause the at least one processor to perform those acts of the method that are performed by the at least one processor. The robot body may communicate, via communications and networking hardware communicatively coupled to the robot's at least one processor, with remote systems and/or remote non-transitory processor-readable storage media. Thus, unless the specific context requires otherwise, references to a robot system's non-transitory processor-readable storage medium, as well as data and/or processor-executable instructions stored in a non-transitory processor-readable storage medium, are not intended to be limiting as to the physical location of the non-transitory processor-readable storage medium in relation to the at least one processor of the robot and the rest of the robot hardware. In other words, a robot system's non-transitory processor-readable storage medium may include non-transitory processor-readable storage media located on-board the robot body (such as non-transitory processor-readable storage media 132, 232, or 304) and/or non-transitory processor-readable storage media located remotely from the robot body (such as non-transitory processor-readable storage medium 354), unless the specific context requires otherwise. Further, a method of operation of a robot system such as any of methods 2100 or 2300 can be implemented as a computer program product or robot control module. Such a computer program product or robot control module comprises processor-executable instructions or data that, when the computer program product or robot control module is stored on a non-transitory processor-readable storage medium of the robot system, and the computer program product or robot control module is executed by at least one processor of the robot, the computer program product or robot control module (or the processor-executable instructions or data thereof) cause the robot system to perform acts of the method.

In some implementations, each of the acts of any of the methods discussed herein (2100 and 2300) are performed by hardware of the robot body, such that the entire method is performed locally at the robot body. In such implementations, the robot carries the at least one sensor and the robot controller, and accessed data (such as platonic representations, grasp primitives, and/or three-dimensional shape models) can be accessed from a non-transitory processor-readable storage medium at the robot body (e.g. a non-transitory processor-readable storage medium of a robot controller local to the robot body such as non-transitory processor-readable storage media 132, 232, or 304). Alternatively, accessed data (such as reusable work primitives or percepts) can be accessed from a non-transitory processor-readable storage medium remote from the robot (e.g., a remote device can send the data, which is received by a communication interface of the robot body).

In other implementations, the robot system includes a remote device (such as remote device 350 in FIG. 3, or a remote processing server), which is communicatively coupled to the robot body by at least one communication interface. In such implementations, acts of capturing sensor data can be performed by at least one sensor positioned at the robot body, and this sensor data can be transmitted to the remote device via the at least one communication interface. In such implementations, acts of accessing a platonic representation (e.g. act 2104), selecting a grasp primitive or selecting a grasp location (e.g. act 2106), and controlling the end effector (e.g. act 2108) can be performed by a robot controller (at least one processor and at least one non-transitory processor-readable storage medium) located at the remote device. Controlling the end effector by a robot controller at a remote device can comprise the robot controller preparing and sending control instructions to the robot body via a communication interface. Further, generation of platonic representations, such as method 2300, including acts 2302, 2312, and 2314 (grouped as 2310) can also be performed by the robot controller at the remote device.

In yet other implementations, the robot system includes a remote device (such as remote device 350 in FIG. 3, or a remote processing server), which is communicatively coupled to the robot body by at least one communication interface. In such implementations, acts of capturing sensor data can be performed by at least one sensor positioned at the robot body, and this sensor data can be transmitted to the remote device via the at least one communication interface. Further, the robot controller can be spread between the robot body and the remote device. For example, the at least one processor of the robot controller can comprise a first processor positioned at the robot body and a second processor positioned at the remote device. Similarly, the at least one non-transitory processor-readable storage medium of the robot controller can comprise a first non-transitory processor-readable storage medium positioned at the robot body and a second non-transitory processor-readable storage medium positioned at the remote device. The first non-transitory processor-readable storage medium stores first processor-executable instructions which when executed by the first processor cause components at the robot body to perform acts of the methods described herein. Similarly, the second non-transitory processor-readable storage medium stores second processor-executable instructions which when executed by the second processor cause components at the remote device to perform acts of the methods described herein. In one example, acts of capturing sensor data (e.g. act 2012) and controlling the end effector (e.g. act 2108) can be performed at the robot body, with captured sensor data being transmitted to the remote device via a communication interface. Further in this example, acts of accessing a platonic representation (e.g. act 2104 of method 2100) and selecting a grasp primitive or selecting a grasp location (e.g. act 2106) can be performed at the remote device, with data indicating the grasp primitive, the grasp location, and/or the platonic representation of the object being transmitted to the robot body via a communication interface.

Several examples of where particular acts can be performed are discussed above. However, these examples are merely illustrative, and any appropriate arrangement for performing certain acts at the robot body or at a remote device can be utilized, as appropriate for a given application.

The robot systems described herein may, in some implementations, employ any of the teachings of U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), US Patent Publication No. US 2021-0307170 A1, and/or U.S. patent application Ser. No. 17/386,877, as well as U.S. Provisional Patent Application Ser. No. 63/151,044, U.S. patent application Ser. No. 17/719,110, U.S. patent application Ser. No. 17/737,072, U.S. patent application Ser. No. 17/846,243, U.S. patent application Ser. No. 17/566,589, U.S. patent application Ser. No. 17/962,365, U.S. patent application Ser. No. 18/089,155, U.S. patent application Ser. No. 18/089,517, U.S. patent application Ser. No. 17/985,215, U.S. patent application Ser. No. 17/883,737, U.S. Provisional Patent Application Ser. No. 63/441,897, and/or U.S. patent application Ser. No. 18/117,205, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present robots, robot systems and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A robot system comprising:
a robot body having at least one end effector;
at least one sensor;
a robot controller including at least one processor and at least one non-transitory processor-readable storage medium storing: a library of three-dimensional shapes, a library of grasp primitives; and processor-executable instructions which, when executed by the at least one processor, cause the robot system to:
capture, by the at least one sensor, sensor data about an object;
access, by the robot controller, a platonic representation of the object comprising a set of at least one three-dimensional shape from the library of the three-dimensional shapes, the platonic representation of the object based at least in part on the sensor data;
select, by the robot controller and from the library of grasp primitives, a grasp primitive based at least in part on at least one three-dimensional shape in the platonic representation of the object; and
control, by the robot controller, the end effector to apply the grasp primitive to grasp the object at a grasp location of the object at least approximately corresponding to the at least one three-dimensional shape upon which the selection of the grasp primitive is at least partially based.

2. The robot system of claim 1, wherein:
the processor-executable instructions further cause the at least one processor to: identify, by the at least one processor, the object; and
the processor-executable instructions which cause the robot controller to access the platonic representation of the object cause the robot controller to: access a three-dimensional model of the object from a database, the three-dimensional model including the platonic representation of the object.

3. The robot system of claim 1, wherein the processor-executable instructions which cause the robot controller to access the platonic representation of the object cause the at least one processor to:
generate the at least one platonic representation of the object, by approximating the object with the set of at least one three-dimensional shape.

4. The robot system of claim 3, wherein the processor-executable instructions which cause the at least one processor to generate the at least one platonic representation of the object, cause the at least one processor to:
identify at least one portion of the object suitable for representation by respective three-dimensional shapes; and
for each portion of the at least one portion:
access a geometric three-dimensional shape model which is similar in shape to the portion; and
transform the accessed geometric three-dimensional shape model to fit the portion.

5. The robot system of claim 4, wherein the processor-executable instructions which cause the at least one processor to, for each portion of the at least one portion, transform the accessed three-dimensional geometric shape model to fit the portion, cause the at least one processor to:
transform a size of the geometric three-dimensional shape model in at least one dimension to fit the size of the geometric three-dimensional shape model to the portion;
transform a position of the geometric three-dimensional shape model to align with a position of the portion; or
rotate the geometric three-dimensional shape model to fit the geometric model to an orientation of the portion.

6. The robot system of claim 1, wherein the processor-executable instructions further cause the robot controller to select the grasp location of the object.

7. The robot system of claim 1, wherein the processor-executable instructions further cause the robot controller to:
access a work objective of the robot system; and
select the grasp location as a location of the object relevant to the work objective.

8. The robot system of claim 1, wherein the processor-executable instructions further cause the robot controller to:
identify, based on the sensor data, at least one graspable feature of the object; and
select one or more of the at least one graspable feature as the grasp location of the object.

9. The robot system of claim 1, wherein the processor-executable instructions further cause the robot controller to:
evaluate grasp-effectiveness for a plurality of grasp primitive-location pairs, each grasp primitive-location pair including a respective three-dimensional shape in the platonic representation of the object and a respective grasp primitive from the library of grasp primitives; and
select the grasp location as a location of the three-dimensional shape in a grasp primitive-location pair having a grasp-effectiveness which exceeds a threshold,
wherein the processor-executable instructions which cause the robot controller to select the grasp primitive cause the robot controller to select the grasp primitive as a grasp primitive in the primitive-location pair having the highest grasp-effectiveness.

10. The robot system of claim 9, wherein the processor-executable instructions which cause the robot controller to evaluate grasp-effectiveness for a plurality of grasp primitive-location pairs cause the robot controller to, for each grasp primitive-location pair:
simulate grasping of the respective three-dimensional shape in the platonic representation of the object, by applying the respective grasp primitive; and
generate a grasp-effectiveness score indicative of effectiveness of simulated grasping.

11. The robot system of claim 1, wherein the processor-executable instructions further cause the robot controller to:
access a grasp heatmap for the object, the grasp heatmap indicative of grasp areas of the object; and
select the grasp location as a grasp area of the object,
wherein the processor-executable instructions which cause the robot controller to select the grasp primitive cause the robot controller to select the grasp primitive based on the at least one three-dimensional shape in the platonic representation of the object which at least approximately corresponds to the grasp location.

12. The robot system of claim 1, wherein the at least one sensor includes one or more sensors selected from a group of sensors consisting of:
an image sensor operable to capture image data;
an audio sensor operable to capture audio data;
a tactile sensor operable to capture tactile data;
a haptic sensor which captures haptic data;
an actuator sensor which captures actuator data indicating a state of a corresponding actuator;
an inertial sensor which captures inertial data;
a proprioceptive sensor which captures proprioceptive data indicating a position, movement, or force applied for a corresponding actuatable member of the robot body; and
a position encoder which captures position data about at least one joint or appendage of the robot body.

13. The robot system of claim 1, wherein:
the processor-executable instructions further cause the at least one sensor to capture further sensor data indicative of engagement between the end effector and the object, as the end effector is controlled to apply the grasp primitive;
the processor executable instructions which cause the robot controller to control the end effector to apply the grasp primitive to grasp the object further cause the robot controller to adjust control of the end effector based on the further sensor data.

14. The robot system of claim 13, wherein the further sensor data is indicative of engagement between the end effector and the object being different from expected engagement between the end effector and the at least one three-dimensional shape upon which the selection of the grasp primitive is at least partially based.

15. The robot system of claim 13, wherein the processor-executable instructions which cause the robot controller to adjust control of the end effector based on the further sensor data cause the robot controller to optimize actuation of at least one member of the end effector to increase grasp effectiveness.

16. The robot system of claim 1, wherein the robot body carries the at least one sensor and the robot controller.

17. The robot system of claim 1, further comprising a remote device remote from the robot body, and a communication interface which communicatively couples the remote device and the robot body, wherein:
the robot body carries the at least one sensor;
the remote device includes the robot controller;
the processor-executable instructions further cause the communication interface to transmit the sensor data from the robot body to the remote device; and
the processor-executable instructions which cause the robot controller to control the end effector cause the robot controller to prepare and send control instructions to the robot body via the communication interface.

18. The robot system of claim 1, further comprising a remote device remote from the robot body, and a communication interface which communicatively couples the remote device and the robot body, wherein:
the robot body carries the at least one sensor, a first processor of the at least one processor, and a first non-transitory processor-readable storage medium of the at least one non-transitory processor-readable storage medium;
the remote device includes a second processor of the at least one processor, and a second non-transitory processor-readable storage medium of the at least one non-transitory processor-readable storage medium;
the processor-executable instructions include first processor-executable instructions stored at the first non-transitory processor-readable storage medium that when executed cause the robot system to:
capture the sensor data by the at least one sensor;
transmit, via the communication interface, the sensor data from the robot body to the remote device; and
control, by the first at least one processor, the end effector to apply the grasp primitive to grasp the object; and
the processor-executable instructions include second processor-executable instructions stored at the second non-transitory processor-readable storage medium that when executed cause the robot system to:
access, from the second non-transitory processor-readable storage medium, the platonic representation of the object;
select, by the second processor, the grasp primitive; and
transmit, via the communication interface, data indicating the grasp primitive and the platonic representation of the object to the robot body.
